(19) United States
(12) Patent Application Publication
(10) Pub. No.: US 2004/0205247 A1
(43) Pub. Date: Oct. 14, 2004

(54) Apparatus and method for performing traffic flow template packet filtering according to internet protocol versions in a mobile communication system

(76) Inventor: Hong-Jin Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/781,865

(22) Filed: Feb. 20, 2004

(30) Foreign Application Priority Data
Feb. 21, 2003 (KR) 2003-11133

(51) Int. Cl. G06F 15/16

(52) U.S. Cl. 709/245

(57) ABSTRACT

An apparatus and method for performing Traffic Flow Template (TFT) filtering according to Internet Protocol (IP) versions in a mobile communication system. The mobile communication system supports an address of a first IP version including first bits and an address of a second IP version including second bits containing the first bits. IP version-based information is extracted from the source IP address. TFT information containing the extracted information is generated and the generated TFT information is transmitted to a Gateway GPRS (General Packet Radio Service) Support Node (GGSN).

### PRIORITY

This application claims priority to an application entitled “APPARATUS AND METHOD FOR PERFORMING TRAFFIC FLOW TEMPLATE PACKET FILTERING ACCORDING TO INTERNET PROTOCOL VERSIONS IN MOBILE COMMUNICATION SYSTEM”, filed in the Korean Intellectual Property Office on Feb. 21, 2003 and assigned Serial No. 2003-11133, the contents of which are incorporated herein by reference.

### BACKGROUND OF THE INVENTION

1. Field of the Invention

The present invention relates to a mobile communication system, and more particularly to an apparatus and method for performing Traffic Flow Template (TFT) packet filtering according to Internet Protocol (IP) versions in a mobile communication system.

2. Description of the Related Art

A Universal Mobile Telecommunication System (UMTS) being a mobile communication system is a system for performing 3^{rd} generation mobile communication. The UMTS supports packet data services as well as voice communication services, and supports high-speed data communications, moving picture communications, and so on. The schematic architecture of the UMTS network will be described with reference to FIG. 1.

FIG. 1 is a block diagram illustrating the architecture of a conventional UMTS network.

Referring to FIG. 1, User Equipment (UE) 111 coupled to a UMTS Terrestrial Radio Access Network (UTRAN) 113 processes a call, and supports both a Circuit Service (CS) and a Packet Service (PS). The UTRAN 113 is configured by at least one Node-B (not shown) and at least one Radio Network Controller (RNC) (not shown). The Node-B is coupled to the UE 111 over a Uu interface, and the RNC is coupled to a Serving GPRS Support Node (SGSN) 115 over an Iu interface. A General Packet Radio Service (GPRS) is a packet data service provided by the UMTS network. The UTRAN 113 performs a protocol conversion operation to transfer radio data or control messages received over an air interface to a Core Network (CN) using a GPRS Tunnelling Protocol (GTP). Here, the CN is referred to as a total of the SGSN 115 and a Gateway GPRS Support Node (GGSN) 119.

The SGSN 115 is a network node for managing subscriber information and location information of the UE 111. The SGSN 115 is coupled to the UTRAN 113 over the Iu interface and is coupled to the GGSN 119 over a Gn interface, such that data and control messages are transmitted and received. The SGSN 115 is coupled to a Home Location Register (HLR) 117 over a Gr interface to manage the subscriber information and location information.

The HLR 117 stores subscriber information and routing information associated with a packet domain, and the like. The HLR 117 is coupled to the SGSN 115 over the Gr interface, and is coupled to the GGSN 119 over a Gc interface. Of course, the HLR 117 can be located within a Public Land Mobile Network (PLMN) when considering roaming of the UE 111. The GGSN 119 corresponds to an endpoint associated with the GTP in the UMTS network, and the GGSN 119 coupled to an external network over a Gi interface can be interworked with the Internet 121, a Packet Domain Network (PDN) or a PLMN.

The architecture of a UMTS core network in which a Traffic Flow Template (TFT) is used will be schematically described with reference to FIG. 2.

FIG. 2 is a schematic block diagram illustrating the UMTS core network based on a conventional TFT.

Before the UMTS core network is described with reference to FIG. 2, it is noted that a packet filtering operation is performed using the TFT and the UMTS core network uses the TFT. The use of the TFT is described as in the following. Packet Data Protocol (PDP) contexts include two types of primary and secondary PDP contexts. The secondary PDP context has the same information as the primary PDP context and can exist only where the primary PDP context is present. Because the secondary PDP context uses information of the primary PDP context as it is, the secondary PDP context is generated after the primary PDP context is generated. The primary and secondary PDP contexts actually use the same information, and only packet data items associated with the primary and secondary PDP contexts are transmitted through different GTP tunnels.

The UMTS core network uses the TFT information as filters for indicating the primary and secondary PDP contexts where the secondary PDP context is activated. As shown in FIG. 2, there is a UMTS core network 200, i.e., a Wideband Code Division Multiple Access (WCDMA) core network 200, in which seven TFTs are stored, and a total of 8 GTP tunnels are generated in relation to secondary PDP contexts corresponding to the seven TFTs and a primary PDP context. IPpacket data incoming over the external network, e.g., the Internet 121, is input into the GGSN 119 over the Gi interface. The GGSN 119 stores the seven TFTs including TFT 1 to TFT 7. A path used for IP packet data input over the Gi Interface is determined by a packet filtering operation through the seven TFTs. The IP packet data filtered by the GGSN 119 using the TFTs is transferred to the SGSN 115 through the Gn interface associated with the determined path, i.e., the determined GTP tunnel. The SGSN 115 transfers the IP packet data received from the GGSN 119 to a Radio Access Network (RAN) 211 through an Iu interface using a corresponding GTP tunnel.

A format of the TFT will now be described with reference to FIG. 3.

FIG. 3 is a block diagram illustrating the format of a conventional TFT.

The TFT is generated from the UE 111, and the generated TFT is transferred to the GGSN 119 through the UTRAN 113 and the SGSN 115. The GGSN 119 filters packet data input through the external network, i.e., the Internet 121 using the TFT for indicating a primary GTP tunnel and a secondary GTP tunnel and searches for a GTP tunnel over which the filtered packet data is transmitted. Where no TFT is present since the primary GTP tunnel using the primary PDP context and the secondary GTP tunnel using the secondary PDP context have the same PDP address, a GTP tunnel over which packet data received from the external network is transmitted, i.e., whether the packet data is transmitted over the primary GTP tunnel or the secondary GTP tunnel cannot be determined.

The TFT has a plurality of packet filters, i.e., 8 packet filters, capable of being identified by unique packet filter identifiers (IDs). The packet filters have specific evaluation precedence indexes for all the TFTs associated with the PDP contexts sharing the same PDP address. Each of the evaluation precedence indexes has one value between 0 and 255. The UE 111 manages a packet filter ID and an evaluation precedence index associated with a packet filter, and generates contents of an actual packet filter. Furthermore, the TFT has one to one correspondence with a PDP context when activating the secondary PDP context. In other words, the TFT can be additionally generated in a PDP context modification procedure initiated by the UE 111 in addition to the PDP context generated in the PDP context activation procedure. The TFT can be corrected through the PDP context modification procedure initiated by the UE 111. One PDP context cannot have more than one TFT associated with it.

Referring to FIG. 3, the TFT includes a “TRAFFIC FLOW TEMPLATE TYPE” field, a “LENGTH OF TRAFFIC FLOW TEMPLATE” field, a “TFT OPERATION CODE” field, a “NUMBER OF PACKET FILTERS” field and a “PACKET FILTER LIST” field. The “TRAFFIC FLOW TEMPLATE TYPE” field indicates a type of the used TFT. A value of the “TRAFFIC FLOW TEMPLATE TYPE” field is typically set to “137” in the UMTS core network 200 and can be differently set according to networks. The “LENGTH OF TRAFFIC FLOW TEMPLATE” field indicates the length of the used TFT, has predetermined length, e.g., 2 bytes, and indicates the length of the remaining fields, except for the “TRAFFIC FLOW TEMPLATE TYPE” field and the “LENGTH OF TRAFFIC FLOW TEMPLATE” field. The “TFT OPERATION CODE” field indicates a TFT operation code. A value indicated by the “TFT OPERATION CODE” field is analyzed and it is determined how the TFT received from the UE 111 is processed according to a result of the analysis. Codes capable of being indicated in the “TFT OPERATION CODE” field are as in the following Table 1.

TABLE 1

| Bits (765) | Description |
|---|---|
| 000 | Spare |
| 001 | Create new TFT |
| 010 | Delete stored TFT |
| 011 | Add packet filters to stored TFT |
| 100 | Replace packet filters in stored TFT |
| 101 | Delete packet filters from stored TFT |
| 110 | Reserved |
| 111 | Reserved |

As shown in the above Table 1, the TFT operation code “000” indicates a spare value, the TFT operation code “001” indicates an operation of creating a new TFT, the TFT operation code “011” indicates an operation of adding packet filters to a stored TFT, the TFT operation code “100” indicates an operation of replacing packet filters in the stored TFT, the TFT operation code “101” indicates an operation of deleting packet filters from the stored TFT, and the TFT operation codes “110” and “111” indicate reserved values, respectively. The GGSN 119 reads the “TFT OPERATION CODE” field and performs a corresponding operation.

The “NUMBER OF PACKET FILTERS” field indicates the number of packet filters set in the used TFT, that is, the number of packet filters existing in a packet filter list of the TFT. For example, where a value of the “TFT OPERATION CODE” is stored as “010”, i.e., where the stored TFT is deleted, a value of the “NUMBER OF PACKET FILTERS” field is set to “0”. Except that the case where the stored TFT is deleted, the number of packet filters is greater than 0 and less than or equal to 8, i.e., 0<number of packet filters≦8. The reason why the number of packet filters is greater than 0 and less than or equal to 8 is because the maximum number of packet filters is 8 in the UMTS core network 200. The TFT information can have from at least one packet filter to a maximum of 8 packet filters. The packet filters are classified into a single-field packet filter based on a single content and a multi-field packet filter based on multiple contents. Here, the single-field packet filter corresponds to one content to be filtered thereby, e.g., a source address, while the multi-field packet filter corresponds to multiple contents to be filtered thereby, e.g., the multiple contents including a source address, a protocol content, a destination address, etc. The “PACKET FILTER LIST” field indicates contents associated with information of packet filters which is actually used, set in the TFT.

The TFT based on the format as shown in FIG. 3 is stored in the GGSN 119. When IP packet data is received from the external Internet 121, the IP packet data is filtered through packet filters stored in the TFT. Here, the IP packet data filtered by the packet filters within the TFT allows a corresponding TFT to use a stored PDP context. For example, when input IP packet data cannot be applied to the first packet filter where three packet filters including the first to third packet filters exist within the TFT, the input IP packet data is applied to the second packet filter. In this manner, if the input IP packet data cannot be applied to the last packet filter, i.e., all packet filters, the input IP packet data uses another GTP tunnel and the subsequent packet filtering operation is tried using the subsequent TFT rather than the TFT associated with a completed packet filtering operation.

Next, a GTP tunnel generation procedure according to PDP context activation will be described with reference to FIG. 4.

FIG. 4 is a flow chart illustrating messages generated in the GTP tunnel generation procedure according to a primary PDP context activation.

In order for data associated with a UMTS packet domain, i.e., packet data, to be transmitted, a GTP tunnel for transmitting the packet data must be generated. Paths for generating the GTP tunnel are classified into a path corresponding to whether the UE 111 sends a request to the core network, i.e., UE-initiated activation, and a path corresponding to whether the external network sends a request to the UMTS core network, i.e., network-requested activation.

Referring to FIG. 4, the UE 111 detects generated packet data and hence generates at least one GTP tunnel to transmit the packet data. The UE 111 transmits an “ACTIVATE PDP CONTEXT REQUEST” message to the SGSN 115 to generate the GTP tunnel at step 411. The “ACTIVATE PDP CONTEXT REQUEST” message contains parameters associated with an Network layer Service Access Point Identifier (NSAPI), a Transaction Identifier (TI), a PDP type, a PDP address, an Access Point Name (APN), Quality of Service (QoS), and the like.

The NSAPI is information generated by the UE 111, and can use a total of 11 values including No. 5 to No. 15. A value of the NSAPI has one to one correspondence with a PDP address and a PDP context ID. The PDP address indicates an IP address of the UE 111 used in a UMTS packet domain, and configures the PDP context information. Here, the PDP context has various information items of the GTP tunnel, and is managed by the PDP context ID. The TI is used between the UE 111, the UTRAN 113 and the SGSN 115. Each GTP tunnel is designated as a specific value to indicate GTP tunnels. The TI and NSAPI are based on an almost identical concept, except that the TI is used between the UE 111, the UTRAN 113 and the SGSN 115, and the NSAPI is used between the UE 111, the SGSN 115 and the GGSN 119. The PDP type indicates a type of a GTP tunnel to be generated through the “ACTIVATE PDP CONTEXT REQUEST” message. Here, types of GTP tunnels include tunnels associated with an IP, a PPP (Point to Point Protocol), a mobile IP, etc. The access point name indicates an access point of a service network to be currently accessed by the UE 111 making a request for GTP channel generation. The QoS parameter indicates quality of packet data to be transmitted through the currently generated GTP tunnel. In other words, the packet data using the GTP tunnel having a high QoS is processed earlier than that using the GTP tunnel having a low QoS.

The SGSN 115 receiving the “ACTIVATE PDP CONTEXT REQUEST” message transmits a “RADIO ACCESS BEARER SETUP” message to the UTRAN 113 so that a radio access bearer between the SGSN 115 and the UTRAN 113 can be set up at step 413. Furthermore, the UTRAN 113 sends the “RADIO ACCESS BEARER SETUP” message to the UE 111 so that a radio access bearer between the UTRAN 113 and the UE 111 can be set up at the above step 413. As the radio access bearer between the SGSN 115 and the UTRAN 113 and the radio access bearer between the UTRAN 113 and the UE 111 are set up, the assignment of resources necessary for transmitting packet data over an air interface is completed. An “INVOKE TRACE” message shown in FIG. 4 will be described as in the following. Where a trace function is activated in the UTRAN 113, the SGSN 115 transfers, to the UTRAN 113, the “INVOKE TRACE” message along with trace information received from an HLR (Home Location Register) (not shown) or an OMC (Operation and Maintenance Center) (not shown) at step 415. Here, the trace function is used for tracing data flow.

If the radio access bearer between the SGSN 115 and the UTRAN 113 is set up, the SGSN 115 transmits a “CREATE PDP CONTEXT REQUEST” message to the GGSN 119 at step 417. At this time, new Tunnel Endpoint IDs (TEIDs) are set between the SGSN 115 and the GGSN 119, and the TEIDs are set so that packet data can be transmitted between network nodes using the GTP tunnels. In other words, the SGSN 115 remembers the TEID of the GGSN 119, and the GGSN 119 remembers the TEID of the SGSN 115. Thus, the “CREATE PDP CONTEXT REQUEST” message contains the TEID to be used when the GGSN 119 transmits the packet data to the SGSN 115.

In response to the “CREATE PDP CONTEXT REQUEST” message, the GGSN 119 transmits a “CREATE PDP CONTEXT RESPONSE” message if PDP context creation is appropriately completed at step 419. Thus, the GTP tunnel generation between the SGSN 115 and the GGSN 119 is completed and hence packet data is transmitted. In response to the “CREATE PDP CONTEXT RESPONSE” message, the SGSN 115 transmits an “ACTIVATE PDP CONTEXT ACCEPT” message to the UE 111 at step 421. As the UE 111 receives the “ACTIVATE PDP CONTEXT ACCEPT” message, a radio channel between the UE 111 and the UTRAN 113 is generated, such that at least one GTP tunnel is completely generated between the UTRAN 113, the SGSN 115 and the GGSN 119. In other words, the UE 111 can transmit and receive all packet data items transferred at its own address. On the other hand, the GTP tunnel generated in the above-described PDP context-related processes has one to one correspondence with one PDP context. As PDP contexts are different if the GTP tunnels are different, the PDP contexts have different tunnel information elements.

The GTP tunnel generation process according to the conventional PDP context activation, i.e., the primary PDP context activation procedure, has been described with reference to FIG. 4. Another GTP tunnel generation process according to secondary PDP context activation will now be described with reference to FIG. 5.

FIG. 5 is a flow chart illustrating messages generated in the GTP tunnel generation process according to the secondary PDP context activation.

The secondary PDP context activation procedure is a process of generating at least one new GTP tunnel by reusing the GTP tunnel information of the previously activated primary PDP context. In other words, the GTP tunnel generated by the secondary PDP context activation procedure is referred to as the secondary GTP tunnel. The secondary GTP tunnel uses the primary PDP context information as it is.

Referring to FIG. 5, the UE 111 transmits an “ACTIVATE SECONDARY PDP CONTEXT REQUEST” message to the SGSN 115 to generate the secondary GTP tunnel at step 511. The “ACTIVATE SECONDARY PDP CONTEXT REQUEST” message contains parameters associated with an NSAPI, a linked TI, a PDP type, a PDP address, an APN (Access Point Name), QoS and etc. Here, the “ACTIVATE SECONDARY PDP CONTEXT REQUEST” message different from the “ACTIVATE PDP CONTEXT REQUEST” message includes the linked TI and uses the previously activated primary PDP context information, i.e., the primary GTP tunnel information as it is. Since the TI is used for indicating GTP tunnels between the UE 111, the UTRAN 113 and the SGSN 115 as described above in relation to FIG. 4, the linked TI is used so that one or more secondary GTP tunnels can use the same information as the primary GTP tunnel.

In response to the “ACTIVATE SECONDARY PDP CONTEXT REQUEST” message, the SGSN 115 transmits a “RADIO ACCESS BEARER SETUP” message to the UTRAN 113 so that a radio access bearer between the UTRAN 113 and the SGSN 115 can be set up at step 513. The UTRAN 113 transmits the “RADIO ACCESS BEARER SETUP” message to the UE 111 so that a radio access bearer between the UTRAN 113 and the UE 111 can be set up at step 515. As the radio access bearer between the SGSN 115 and the UTRAN 113 and the radio access bearer between the UTRAN 113 and the UE 111 are set up, the assignment of resources necessary for transmitting packet data by radio is completed.

If the radio access bearer between the UTRAN 113 and the SGSN 115 is set up, the SGSN 115 transmits a “CREATE PDP CONTEXT REQUEST” message to the GGSN 119 at step 517. At this time, the SGSN 115 transmits a primary NSAPI to indicate that GTP tunnels to be generated are secondary GTP tunnels. A value of the primary NSAPI has one to one correspondence with the previously activated primary PDP context information. Thus, the primary PDP context information can be used by referring to the primary NSAPI value. Furthermore, the SGSN 115 transmits the “CREATE PDP CONTEXT REQUEST” message containing a TFT. The purpose of the TFT is to indicate the primary and secondary GTP tunnels. In other words, the TFT is not stored in the primary GTP tunnel and the TFT is stored only in the secondary GTP tunnels. As in the primary GTP tunnel generation process, new TEIDs is set between the SGSN 115 and the GGSN 119, and the TEIDs are set so that packet data can be transmitted between network nodes over the GTP tunnels. In other words, the SGSN 115 remembers the TEID of the GGSN 119, and the GGSN 119 remembers the TEID of the SGSN 115. Thus, the “CREATE PDP CONTEXT REQUEST” message contains the TEID to be used when the GGSN 119 transmits the packet data to the SGSN 115.

If PDP context creation is appropriately completed in response to the “CREATE PDP CONTEXT REQUEST” message, the GGSN 119 transmits a “CREATE PDP CONTEXT RESPONSE” message at step 519. Thus, the secondary GTP tunnel generation between the SGSN 115 and the GGSN 119 is completed and hence packet data can be transmitted over secondary GTP tunnels. In response to the “CREATE PDP CONTEXT RESPONSE” message, the SGSN 115 transmits an “ACTIVATE PDP CONTEXT ACCEPT” message to the UE 111 at step 521. As the UE 111 receives the “ACTIVATE PDP CONTEXT ACCEPT” message, a radio channel between the UE 111 and the UTRAN 113 is generated, such that the secondary GTP tunnel is completely generated between the UTRAN 113, the SGSN 115 and the GGSN 119. In other words, the UE 111 can transmit and receive all packet data items transferred at its own address. On the other hand, one secondary GTP tunnel generated in the above-described PDP context-related processes has one to one correspondence with one PDP context.

A TFT processing operation according to the TFT operation codes described in relation to FIG. 3 will now be described. First, a new TFT creation process will now be described with reference to FIG. 6.

FIG. 6 is a block diagram illustrating TFT information necessary for creating a new TFT.

When the TFT operation code is set to “001” as described above in relation to FIG. 3, the new TFT is created. On the other hand, a field indicated by “0” as shown in FIG. 6 is spare, and its field is unspecified. The unspecified field is set to “0”. The “PACKET FILTER LIST” field shown in FIG. 3 will be described in detail with reference to FIG. 6. Referring to FIG. 6, each “PACKET FILTER IDENTIFIER” field contained in the “PACKET FILTER LIST” field is used for indicating a corresponding packet filter from the packet filters set within the TFT. As described above, since the maximum number of packet filters capable of being set within the TFT is 8 as an example, the maximum number of packet filter IDs is 8. In FIG. 6, the packet filter IDs are expressed by the bits 0˜2, and the remaining bits 4˜7 are spare.

Next, each “PACKET FILTER EVALUATION PRECEDENCE” field contained in the “PACKET FILTER LIST” field indicates the precedence for a packet filter among all packet filters set within the TFT. In other words, the “PACKET FILTER EVALUATION PRECEDENCE” field indicates the order of packet filtering operations for packet data received from the external network. The lower the value of the “PACKET FILTER EVALUATION PRECEDENCE” field is, the higher the precedence of the packet filter for the packet data received from the external network is. If the packet data is received from the external network, a packet filter having the lowest value of the “PACKET FILTER EVALUATION PRECEDENCE” field among TFT packet filters stored in the GGSN 119 is first applied to the packet data. Where the packet filter having the lowest value of the “PACKET FILTER EVALUATION PRECEDENCE” field does not match a header of the received packet data, a packet filter having the second lowest value of the “PACKET FILTER EVALUATION PRECEDENCE” field is applied to the received packet data. Each “LENGTH OF PACKET FILTER CONTENTS” field contained in the “PACKET FILTER LIST” field indicates the length of corresponding packet filter contents.

Finally, each “PACKET FILTER CONTENTS” field contained in the “PACKET FILTER LIST” field includes a packet filter component type ID and the length of packet filter contents is variable. The length of the “PACKET FILTER CONTENTS” field is variable because the lengths of packet filters are different from each other and the number of packet filters set within the TFT is variable. After the packet filter component type ID is used once, it cannot be used for any other packet filter. The packet filters cannot be configured on the basis of both an IP version 4 (IPv4) source address type and an IP version 6 (IPv6) source address type within the TFT. A single destination port type and a destination port range type cannot be used together for the packet filters. The packet filter component types and packet filter component type IDs as described above are shown in the following Table 2.

TABLE 2

| Bits (76543210) | Description |
|---|---|
| 00010000 | IPv4 source address type |
| 00100000 | IPv6 source address type |
| 00110000 | Protocol identifier/Next header type |
| 01000000 | Single destination port type |
| 01000001 | Destination port range type |
| 01010000 | Single source port type |
| 01010001 | Source port range type |
| 01100000 | Security parameter index type |
| 01110000 | Type of service/Traffic class type |
| 10000000 | Flow label type |
| All other values | Reserved |

As shown in Table 2, one packet filter consists of a plurality of packet filter components. However, the current UMTS does not use all the packet filter types. For example, a Transmission Control Protocol/User Datagram Protocol (TCP/UDP) port range is used as a packet filter component, but each TCP/UDP port is not used as the packet filter component. The plurality of packet filter components can configure the packet filter. For example, Terminal Equipment (TE) can classify IPv6 packet data having a TCP port range between 4500 and 5000 at an address of “::172.168.8.0/96”, and can configure a packet filter so that Packet filter identifier=1; IPv6 Source Address={::172.168.8.0[FFFF:FFFF:FFFF:FFFF:FFFF:FFFF:0:0]}; TCP Protocol Number=6; and Destination Port range=4500 to 5000. An operation of classifying packet data using a plurality of parameters is referred to as a multi-field classification. The packet filter component types will now be described.

First, the “IPv4 source address type” field shown in the above Table 2 will be described.

The “IPv4 source address type” includes a four-octet IPv4 address field and a four-octet IPv4 address mask field. The IPv4 address field is first transmitted before the IPv4 address mask field. Here, an IPv4 address is expressed as 32 bits. For example, the IPv4 address is expressed as “10.2.10.3”.

There may be a case where the IPv4 address field cannot be set within the TFT carried by a secondary PDP context request message used for accessing a service network associated with an Access Point Name (APN), and so on. In other words, when the secondary PDP context is initially activated, the UE 111 receives an IP address over a Domain Name Service (DNS) server in relation to an initially accessed service network. Since a secondary PDP context activation message to be transferred is already in a standby state, the packet filter contents of the TFT cannot be changed. Because the UE 111 recognizes an IP address of a corresponding service received from the DNS server at the next access subsequent to the initial access, the set TFT packet filter contents can use the “IPv4 source address type” field. Furthermore, if the UE 111 does not initially access a new service network but transmits the secondary PDP context activation request message to communicate with another UE, packet filter contents based on the “IPv4 source address type” field in the TFT can be used.

Second, the “IPv6 source address type” field shown in Table 2 will be described. The “IPv6 source address type” field includes a sixteen-octet IPv6 address field and a sixteen-octet IPv6 address mask field. The IPv6 address field is first transmitted before the IPv6 address mask field. An IPv6 address is expressed as 128 bits. When the IPv6 address is used, a system based on the IPv6 address can accommodate the number of subscribers corresponding to 2⁹⁶ times the number of subscribers capable of being accommodated in a system based on the above-described IPv4 address. Since the IPv6 address-based system can further accommodate a large number of subscribers compared with the IPv4 address-based system, use of the IPv6 address increases.

A structure of the IPv6 address will now be described with reference to FIG. 7.

FIG. 7 is a block diagram illustrating the conventional IPv6 address.

Referring to FIG. 7, the IPv6 address is expressed as 128 bits, and a node address is expressed as 128 bits.

The most serious drawback associated with the IPv6 address is that the length of the IPv6 address is very long. For example, the IPv4 address can be expressed as “10.2.10.3”, while the IPv6 address is expressed as “ABCD:1234:EF12:5678:2456:9ABC”. Since the IPv6 address is very long, it is difficult for subscribers to remember the IPv6 address. Furthermore, there is another problem in that heavy load of the system and additional cost occur because a computation process for the 128 bits is performed in relation to the IPv6 address.

The “Protocol identifier/Next header type” field shown in Table 2 will now be described. The “Protocol identifier/Next header type” field includes a one-octet protocol identifier, e.g., indicating “IPv4”, or a next header type, e.g., indicating “IPv6”. The “Single destination port type” field shown in Table 2 includes a two-octet destination port number. A value of the “Single destination port type” field can be a UDP or TCP port value according to a protocol field value of an IP header. The “Destination port range type” field shown in Table 2 includes a two-octet destination port range low limit field and a two-octet destination port range high limit field. A value indicated by the “Destination port range type” field can be a UDP or TCP port range according to a protocol field value of an IP header.

The “Single source port type” field shown in Table 2 includes a two-octet source port number. The source port number can be a UDP or TCP port value according to the protocol field value of an IP header. The “Source port range type” field shown in Table 2 includes a two-octet source port range low limit field and a two-octet source port range high limit field. A value indicated by the “Source port range type” field can be a UDP or TCP port range according to the protocol field value of an IP header. The “Security parameter index type” field shown in Table 2 includes a four-octet IPSec Security Parameter Index (SPI). The “Type of service/Traffic class type” field shown in the above Table 2 includes a one-octet Type-of-Service (IPv4)/Traffic Class (IPv6) field and a one-octet Type-of-Service mask (IPv4)/Traffic Class mask (IPv6) field. Finally, the “Flow label type” field includes a three-octet IPv6 flow label. The bits 7 through 4 of the first octet are spare, and the remaining 20 bits contain an IPv6 flow label.

The new TFT creation process corresponding to the TFT operation code “001” has been described with reference to FIG. 6. Next, a process of deleting a stored TFT corresponding to the TFT operation code “010”, a process of adding packet filters to the stored TFT corresponding to the TFT operation code “011”, and a process of replacing packet filters in the stored TFT corresponding to the TFT operation code “100” will be described with reference to FIG. 8.

FIG. 8 is a block diagram illustrating TFT information necessary for deleting a stored TFT, adding packet filters to the stored TFT or replacing packet filters in the stored TFT.

Referring to FIG. 8, after a “TFT OPERATION CODE” field is confirmed irrespective of a packet filter list where a TFT is deleted, the GGSN 119 deletes the TFT having a TFT type desired to be deleted among the TFTs stored in the GGSN 119 if the “TFT OPERATION CODE” field indicates “010” being a value representing a preset TFT deletion. Where packet filters are added to the stored TFT, the packet filter addition process uses the same information as the TFT deletion process. In the packet filter addition process, contents of a corresponding packet filter list are added to the stored TFT. Where packet filters in the stored TFT are replaced, the packet filter replacing process uses the same information as the TFT deletion process and the packet filter addition process. After the packet filters are deleted from the stored TFT, contents of a corresponding packet filter list are inserted.

The process of deleting a stored TFT corresponding to the TFT operation code “010”, the process of adding packet filters to the stored TFT corresponding to the TFT operation code “011”, and the process of replacing packet filters in the stored TFT corresponding to the TFT operation code “100” have been described with reference to FIG. 8. Next, a process of deleting packet filters from the stored TFT corresponding to the TFT operation code “101” will be described with reference to FIG. 9.

FIG. 9 is a block diagram illustrating TFT information necessary for deleting packet filters from the stored TFT.

As shown in FIG. 9, only packet filter IDs are considered irrespective of a packet filter list where the packet filters are deleted from the stored TFT. The GGSN 119 deletes packet filters corresponding to packet filter IDs contained in the TFT information received from the UE 111 from the packet filters of the stored TFT. FIG. 9 shows the case where N number of packet filters consisting of from a 1^{st} packet filter to an N^{th} packet filter are deleted from the TFT.

Next, a TFT packet filtering operation will be described with reference to FIG. 10.

FIG. 10 is a block diagram illustrating the TFT packet filtering operation of a conventional UMTS core network.

We assume that each TFT has only a single packet filter for convenience of explanation when the TFT packet filtering operation is described with reference to FIG. 10. The GGSN 119 of the UMTS core network 200 stores a total of four TFTs, and each of the TFTs includes one packet filter. The fact that the four TFTs are stored means that the GGSN 119 is coupled to five GTP tunnels containing one primary GTP tunnel for a primary PDP context and four secondary GTP tunnels for secondary PDP contexts along with the SGSN 115, and the five GTP tunnels shares the same PDP context. The five GTP tunnels are indicated by the TFTs.

If the packet filtering operation based on the four TFTs for packet data received from the external network, e.g., the Internet 121, is unsuccessful, the packet data input from the Internet 121 is transmitted to the SGSN 115 only through the primary GTP tunnel for the primary PDP context. For example, assuming that (Type Of Service (TOS) is “0x30”, a protocol is TCP, a Source Address (SA) is “1.1.1.1”, a Destination Address (DA) is “2.2.2.2”, a Source Port (SP) number is “200” and a Destination Port (DP) number is “50” in relation to the packet data received from the Internet 121, the packet data does not match packet filter contents for TFT 1 and TFT 2, such that the packet filtering operation for the packet data is not performed in relation to the TFT 1 and TFT 2. However, since the packet data matches packet filter contents for TFT 3, the packet filtering operation for the packet data is performed in relation to the TFT 3 and a result of the packet filtering operation is transferred to the SGSN 115 through a GTP tunnel corresponding to the TFT 3. The packet data received from the Internet 121 cannot be filtered in relation to the TFT 1 and TFT 2 because the SA associated with the packet filter contents for the TFT 1 is “3.3.3.3” and it does not match the SA of “1.1.1.1” contained in the received packet data, and because a protocol associated with the packet filter contents for the TFT 2 is Internet Control Message Protocol (ICMP) and it does not match TCP being a protocol of the received packet data. Furthermore, the packet data received from the Internet 121 is filtered in relation to the TFT 3 because the TOS associated with the TFT packet filter contents is “0x30” and it matches “0x30” being the TOS contained in the received packet data.

As described above, the TFT is generated in relation to the PDP context (or GTP tunnel) in the secondary PDP context activation procedure. Through a UE-initiated PDP context modification procedure, the UE 111 can add/modify/delete the PDP context associated with the TFT generated in the PDP context activation procedure. As described above, one PDP context has only one TFT. Here, where the UE 111 generates a new TFT or modifies a TFT stored in the GGSN 119, the TFT must store at least one valid packet filter. If the valid packet filter does not exist in the stored TFT, the UE 111 fails to perform the UE-initiated PDP context modification procedure. The GGSN 119 transmits, to the UE 111, an error code indicating failure in the UE-initiated PDP context modification procedure for the TFT. At this time, the TFT is deleted if a PDP context associated with the TFT is deactivated.

Next, IP addresses will be described in detail as in the following.

The IP addresses are classified into an IPv4 address and an IPv6 address according to address versions. A network using the IPv4 address is referred to as an “IPv4 network”, and a network using the IPv6 address is referred to as an “IPv6 network”. The UMTS uses an IPv6-embedded IPv6 address so that IP communication can be performed between the IPv4 network and the IPv6 network. Here, the IPv4-embedded IPv6 address includes an IPv4-compatible IPv6 address and an IPv4-mapped IPv6 address. The IPv4-compatible IPv6 address and the IPv4-mapped IPv6 address will now be described.

(1) IPv4-Compatible IPv6 Address

An IPv4-compatible IPv6 address is selectively used where an opposite network can support the IPv6 address, an opposite or destination IPv4 address can be recognized, and communication is performed through the IPv6 network. A format of the IPv4-compatible IPv6 address will be described with reference to FIG. 11.

FIG. 11 is a block diagram illustrating a format of the conventional IPv4-compatible IPv6 address.

Referring to FIG. 11, the IPv4-compatible IPv6 address is expressed as 128 bits since the IPv4-compatible IPv6 address is basically an IPv6 address. An IPv4 address is inserted into low-order 32 bits of the IPv4-compatible IPv6 address. In other words, a destination IPv4 address is inserted into the low-order 32 bits of the IPv4-compatible IPv6 address, and 0 s are inserted into the remaining 96 bits of the IPv4-compatible IPv6 address.

The architecture of a network in which the IPv4-compatible IPv6 address will be described with reference to FIG. 12.

FIG. 12 is a block diagram illustrating the architecture of a network in which the IPv4-compatible IPv6 address is used.

Referring to FIG. 12, networks 1211 and 1213 use both an IPv4 address and an IPv6 address. Where a destination address of packet data to be transmitted is the IPv4 address, the network 1211 inserts an IPv4 address into low-order 32 bits of the IPv4-compatible IPv6 address as shown in FIG. 11, and transmits the IPv4-compatible IPv6 address to the network 1213. If so, the network 1213 receives the packet data of the IPv4-compatible IPv6 address from the network 1211, and the network 1213 detects the IPv4 address contained in the low-order 32 bits of the IPv4-compatible IPv6 address. Here, the IPv4 address must be unique, and a unique IPv4 address must be assured. The IPv4-compatible IPv6 address is expressed as in the following.

0:0:0:0:0:0:165.213.138.35→::165.213.138.35

The IPv4-compatible IPv6 address holds the IPv4 address inserted into the low-order 32 bits of the IPv4-compatible IPv6 address. Similarly, the IPv4-compatible IPv6 address is a unique address.

(2) IPv4-Mapped IPv6 Address

An IPv4-mapped IPv6 address is selectively used where an opposite network does not support an IPv6 address, but communication is performed using the IPv6 address. A format of the IPv4-mapped IPv6 address will be described with reference to FIG. 13.

FIG. 13 is a block diagram illustrating the format of a conventional IPv4-mapped IPv6 address.

Referring to FIG. 13, the IPv4-mapped IPv6 address is expressed as 128 bits since the IPv4-compatible IPv6 address is basically an IPv6 address. An IPv4 address is inserted into low-order 32 bits of the IPv4-mapped IPv6 address. In other words, a destination IPv4 address is inserted into the low-order 32 bits of the IPv4-mapped IPv6 address, Is are inserted into high-order 16 bits of the IPv4-mapped IPv6 address subsequent to the inserted low-order 32 bits of the IPv4 address, and 0s are inserted into the remaining 80 bits of the IPv4-mapped IPv6 address.

The architecture of a network in which the IPv4-mapped IPv6 address is used will be described with reference to FIG. 14.

FIG. 14 is a block diagram illustrating the architecture of a network in which the IPv4-mapped IPv6 address is used.

Referring to FIG. 14, a network 1411 uses both an IPv4 address and an IPv6 address, and a network 1413 uses only an IPv4 address. Where a destination address of packet data to be transmitted by the network 1411 is the IPv4 address, the network 1411 inserts an IPv4 address into low-order 32 bits of the IPv4-mapped IPv6 address as in the IPv4-compatible IPv6 address shown in FIG. 13, and transmits the IPv4-mapped IPv6 address to the network 1413. If so, the network 1413 receives the packet data of the IPv4-mapped IPv6 address from the network 1411, and the network 1413 detects the IPv4 address contained in the low-order 32 bits of the IPv4-mapped IPv6 address. Here, the IPv4-mapped IPv6 address is expressed as in the following.

0:0:0:0:0:0:FFFF:165.213.138.35→::FFFF:165.213.138.35

The IPv4-mapped IPv6 address holds the IPv4 address inserted into the low-order 32 bits of the IPv4-mapped IPv6 address. The IPv4-mapped IPv6 address is different from the IPv4-compatible IPv6 address in that “0xFFFF” is inserted into high-order 16 bits of the IPv4-mapped IPv6 address subsequent to the inserted low-order 32 bits of the IPv4 address.

In relation to the above-described TFT packet filter component types, an IPv4 source address represents a 32-bit address using the IPv4 address. As the number of subscribers of the current mobile communication system increases by geometric progression, IPv6 addresses will be widely used so that the IP addresses can be appropriately assigned. For this reason, TFT packet filter component types necessary for filtering packet data associated with the IPv6 addresses have been proposed. However, since the IPv6 address is expressed as 128 bits, it causes a significant load in terms of bit computation as compared with the IPv4 address expressed as 32 bits.

Packet data input into the GGSN 119 from the external network endures packet filtering operations through TFTs stored in the GGSN 119, and the packet filtering operations through the TFTs are sequentially performed from the lowest packet filter evaluation precedence to the highest packet filter evaluation precedence in relation to one or more packet filters stored in each TFT. For example, where five TFTs are stored in the GGSN 119 and each of the TFTs stores four packet filters, packet data received from the external network, i.e., the Internet 121, endures a packet filtering operation associated with four packet filters of the first TFT of the five TFTs. Then, if the packet filtering operation is unsuccessful, the packet data endures a packet filtering operation associated with four filters of the second TFT of the five TFTs. Where the number of TFTs stored in the GGSN 119 abruptly increases or an amount of packet data received from the external network 121 abruptly increases until the packet filtering operation for the packet data is successful, 128-bit computation associated with the IPv6 address degrades the performance of TFT packet filtering. The degraded packet filtering performance can adversely affect the UMTS core network.

### SUMMARY OF THE INVENTION

Therefore, the present invention has been made and it is one object of the present invention to provide an apparatus and method for performing Traffic Flow Template (TFT) packet filtering according to the IP versions of IP addresses in a mobile communication system.

It is another object of the present invention to provide an apparatus and method for performing TFT packet filtering using information commonly used in IP addresses based on different IP versions in a mobile communication system.

It is yet another object of the present invention to provide an apparatus and method for performing TFT packet filtering, which can minimize an amount of computation required for performing the packet filtering according to the IP versions of IP addresses associated with input packet data in a mobile communication system.

In accordance with a first embodiment of the present invention, the above and other objects can be accomplished by an apparatus for performing TFT filtering according to Internet Protocol (IP) versions in a mobile communication system which is capable of supporting an address of a first IP version consisting of first bits and an address of a second IP version consisting of second bits containing the first bits. The apparatus comprises a controller for extracting the first bits of the first IP version address from the second IP version address when TFT information is received and the received TFT information corresponds to the second IP version address into which the first IP version address is inserted, and for generating new TFT information from the extracted first bits of the first IP version address; and a memory for storing the received TFT information as the new TFT information.

In accordance with a second embodiment of the present invention, the above and other objects can be accomplished by an apparatus for performing TFT filtering according to IP versions in a mobile communication system, that is capable of supporting an address of a first IP version consisting of first bits and an address of a second IP version consisting of second bits containing the first bits. The apparatus comprises User Equipment (UE) for extracting the first bits of the first IP version address from the second IP version address when a source IP address is the second IP version address into which the first IP address is inserted, for generating TFT information from the extracted first bits of the first IP version address, and for transmitting the generated TFT information to a Gateway GPRS (General Packet Radio Service) Support Node GGSN; and the GGSN for storing the TFT information received from the UE, for extracting the first bits representing the first IP version address from the second IP version address when an IP address of received packet data corresponds to the second IP version and the IP address is the second IP version address into which the first IP version address is inserted, and for performing the TFT packet filtering using the first bits extracted from the received packet data.

In accordance with the another embodiment of the present invention, the above and other objects can be accomplished by the provision of a method for performing TFT filtering according to IP versions in a mobile communication system capable of supporting an address of a first IP version consisting of first bits and an address of a second IP version consisting of second bits containing the first bits. The method comprises the steps of when TFT information is received and the received TFT information corresponds to the second IP version address into which the first IP version address is inserted, extracting the first bits of the first IP version address from the second IP version address; generating new TFT information from the extracted first bits of the first IP version address; when an IP address of received packet data corresponds to the second IP version and the IP address is the second IP version address into which the first IP version address is inserted, extracting the first bits representing the first IP version address from the second IP version address; and performing the TFT packet filtering using the first bits extracted from the received packet data.

In accordance with the a further embodiment of the present invention, the above and other objects can be accomplished by the provision of a method for performing TFT filtering according to IP versions in a mobile communication system capable of supporting an address of a first IP version consisting of first bits and an address of a second IP version consisting of second bits containing the first bits. The method comprises the steps of when a source IP address is the second IP address into which the first IP version address is inserted, allowing User Equipment (UE) to extract the first bits of the first IP version address from the second IP version address; allowing the UE to generate packet filter contents from the extracted first bits of the first IP version address, to generate TFT information containing the packet filter contents and to transmit the generated TFT information to a Gateway GPRS (General Packet Radio Service) Support Node (GGSN); allowing the GGSN to store the TFT information received from the UE and to extract the first bits representing the first IP version address from the second IP version address when an IP address of received packet data corresponds to the second IP version and the IP address is the second IP version address into which the first IP version address is inserted; and allowing the GGSN to perform the TFT packet filtering using the first bits extracted from the received packet data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the architecture of a conventional Universal Mobile Telecommunication System (UMTS) network;

FIG. 2 is a block diagram illustrating a UMTS core network based on a conventional Traffic Flow Template (TFT);

FIG. 3 is a block diagram illustrating a format of the conventional TFT;

FIG. 4 is a flow chart illustrating messages generated in a GPRS (General Packet Radio Service) Tunnelling Protocol (GTP) tunnel generation process according to a primary (Packet Data Protocol (PDP) context activation;

FIG. 5 is a flow chart illustrating messages generated in a GTP tunnel generation process according to the secondary PDP context activation;

FIG. 6 is a block diagram illustrating the format of a new TFT;

FIG. 7 is a block diagram illustrating the format of a conventional IPv6 address;

FIG. 8 is a block diagram illustrating TFT information necessary for deleting a stored TFT, adding packet filters to the stored TFT or replacing packet filters in the stored TFT;

FIG. 9 is a block diagram illustrating TFT information necessary for deleting packet filters from the stored TFT;

FIG. 10 is a block diagram illustrating a TFT packet filtering operation performed by the conventional UMTS core network;

FIG. 11 is a block diagram illustrating the format of a conventional IPv4-compatible IPv6 address;

FIG. 12 is a block diagram illustrating the architecture of a network in which the IPv4-compatible IPv6 address is used;

FIG. 13 is a block diagram illustrating the format of a conventional IPv4-mapped IPv6 address;

FIG. 14 is a block diagram illustrating the architecture of a network in which the IPv4-mapped IPv6 address is used;

FIG. 15 is a block diagram illustrating the architecture of a UMTS network for performing a function in accordance with an embodiment of the present invention;

FIG. 16 is a block diagram illustrating the internal structure of a TFT packet-filtering device for performing a function in accordance with an embodiment of the present invention;

FIG. 17 is a view illustrating TFT information stored in a TFT table 1651 shown in FIG. 16;

FIGS. 18A and 18B are flow charts illustrating a TFT packet filtering operation when an IPv6 source address type method is used;

FIGS. 19A and 19B are flow charts illustrating a TFT packet filtering operation when an IPv4-embedded IPv6 source address type method is used;

FIG. 20 is a block diagram illustrating a general TFT packet filtering operation executed by a TFT packet filtering procedure 1611 shown in FIG. 16;

FIG. 21 is a block diagram illustrating a TFT packet filtering operation using the IPv6 source address type method executed by the TFT packet filtering procedure 1611 shown in FIG. 16;

FIG. 22 is a block diagram illustrating a TFT packet filtering operation using the IPv4-embedded IPv6 source address type method performed by the TFT packet filtering procedure 1611 shown in FIG. 16;

FIG. 23 is a table illustrating an amount of bit computation according to a TFT packet filtering operation when the IPv6 source address type method and IPv4-embedded IPv6 source address type method are used as compared with an amount of bit computation according to the general TFT packet filtering operation in accordance with an embodiment of the present invention; and

FIG. 24 is a flow chart illustrating a TFT packet filter generation process when the IPv4-embedded IPv6 source address type method is used.

### DETAILED DESCRIPTION OF THE PREFERRED EMBODIMENTS

Embodiments of the present invention will be described in detail with reference to the accompanying drawings. In the following description, only functions and configurations necessary for understanding the present invention will be described. Furthermore, a detailed description of known functions configurations incorporated herein will be omitted for conciseness.

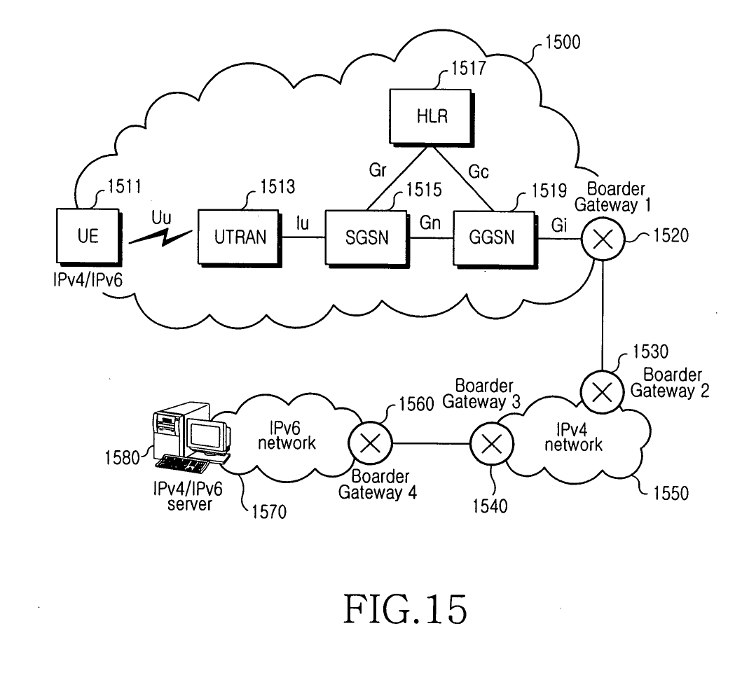

FIG. 15 is a block diagram illustrating the architecture of a Universal Mobile Telecommunication System (UMTS) network for performing a function in accordance with an embodiment of the present invention.

Referring to FIG. 15, the UMTS network includes an IPv6 network 1500 using an IPv6 Internet Protocol (IP) version 6 (IPv6) address, an IPv4 network 1550 using an IP version 4 (IPv4) address, and an IPv6 network 1570 using an IPv6 address. For example, the IPv6 network 1500 contained in the UMTS network will be described.

First, User Equipment (UE) 1511 coupled to a UMTS Terrestrial Radio Access Network (UTRAN) 1513 processes a call, and supports both a Circuit Service (CS) and a Packet Service (PS). The UE 1511 is a dual mode-based UE capable of supporting both the IPv4 address and the IPv6 address in accordance with an embodiment of the present invention. The UE 1511 configures Traffic Flow Template (TFT) information as mentioned in the “Description of the Related Art” above. In accordance with an embodiment of the present invention, the UE 1511 generates at least one TFT packet filter using a total or part of the IP address. A procedure of generating the TFT packet filter using the total or part of the IP address will be described in detail.

The UTRAN 1513 is configured by at least one Node-B (not shown) and at least one Radio Network Controller (RNC (not shown). The Node-B is coupled to the UE 1511 over a Uu interface, and the RNC is coupled to a Serving GPRS Support Node (SGSN) 1515 over an Iu interface. A General Packet Radio Service (GPRS) is a packet data service provided by the UMTS network. The UTRAN 1513 performs a protocol conversion operation to transfer radio data or control messages received by radio to a Core Network (CN) using a GPRS Tunnelling Protocol (GTP). Here, the CN is referred to as a total of the SGSN 1515 and a GGSN 1519.

The SGSN 1515 is a network node for managing subscriber information and location information of the UE 1511. The SGSN 1515 is coupled to the UTRAN 1513 over the Iu interface and is coupled to the GGSN 1519 over a Gn interface, such that data and control messages are transmitted and received. The SGSN 1515 is coupled to a Home Location Register (HLR) 1517 over a Gr interface to manage the subscriber information and location information.

The HLR 1517 stores subscriber information and routing information associated with a packet domain, etc. The HLR 1517 is coupled to the SGSN 1515 over the Gr interface, and is coupled to the GGSN 1519 over a Gc interface. Of course, the HLR 1517 can be located within a Public Land Mobile Network (PLMN) when considering roaming of the UE 1511. The GGSN 1519 corresponds to an endpoint associated with the GTP in the UMTS network, and the GGSN 1519 coupled to an external network over a Gi interface and can be interworked with the Internet, a Packet Domain Network (PDN) or a PLMN. The IPv6 network 1500 is coupled to the IPv4 network 1550 through the first boarder gateway 1500. The first boarder gateway 1520 located at an endpoint of the IPv6 network 1500 performs a message filtering function, a Network Address Translation (NAT) function, and so on.

In accordance with this embodiment of the present invention, the first boarder gateway 1520 transfers packet data received from the IPv6 network 1500 to the second boarder gateway 1530. Here, the packet data received from the IPv6 network 1500 has an IPv6 address, but the IPv4 network 1550 coupled to the second boarder gateway 1530 supports only an IPv4 address. Thus, the first boarder gateway 1520 extracts a low-order 32-bit IPv6 address from the packet data received from the IPv6 network 1500 to generate an IPv4 header. The first boarder gateway 1520 adds the generated IPv4 header to the packet data to transmit the packet data to the IPv4 network 1550. As described in the “Description of the Related Art” above, the UMTS uses an IPv4-embedded IPv6 address so that IP communication and can be performed between the IPv4 network and the IPv6 network. Here, the IPv4-embedded IPv6 address includes an IPv4-compatible IPv6 address and an IPv4-mapped IPv6 address. The IPv4 network 1550 removes the IPv4 header from the packet data that is received from the second boarder gateway 1530, and transfers, through the third boarder gateway 1540, packet data from which the IPv4 header has been removed. If so, the third boarder gateway 1540 transfers the packet data through the fourth boarder gateway 1560. Subsequently, the IPv6 network 1570 receives packet data having the IPv6 address. As described above, the procedure of externally transmitting the packet data from the IPv6 network 1500 has been described. When the IPv6 network 1500 receives the packet data incoming from an external network, the packet is capsulated or de-capsulated according to IP address versions. Hereinafter, the packet data having an IPv4 address is referred to as “IPv4 packet data” and the packet data having an IPv6 address is referred to as “IPv6 packet data” for convenience of explanation.

Furthermore, the second boarder gateway 1530 performs a function of a boundary router for the IPv4 network 1550 and also performs a general IPv4 router function. The third boarder gateway 1540 performs a function of a boarder router for the IPv4 network 1550 and also performs a general IPv4 router function. The fourth boarder gateway 1560 performs a function of a boundary router for the IPv6 network 1570 and performs the same function as the first boarder gateway 1520. An IPv4/IPv6 server 1580 is a dual mode server capable of accommodating both the IPv4 packet data and the IPv6 packet data. The IPv4/IPv6 server 1580 uses an IPv4-compatible IPv6 address or an IPv4-mapped IPv6 address to communicate with the UE 1511 of the UMTS network via the IPv4 network 1550.

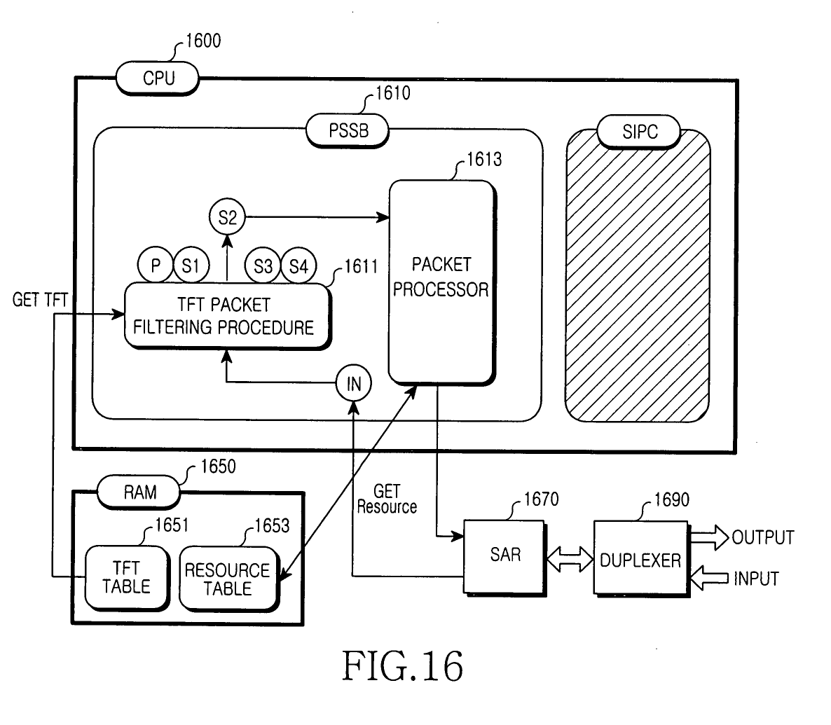

The internal structure of a TFT packet-filtering device for performing a function in accordance with an embodiment of the present invention will be described with reference to FIG. 16.

FIG. 16 is a block diagram illustrating the internal structure of the TFT packet-filtering device for performing a function in accordance with the embodiment of the present invention.

Referring to FIG. 16, the TFT packet-filtering device includes a Central Processing Unit (CPU) 1600, a Random Access Memory (RAM) 1650 and a Segmentation And Reassembly (SAR) module 1670 and a duplexer 1690. The CPU 1600 processes packet data incoming from the external network, i.e., the Internet, through the Gi interface of the GGSN, and performs an overall control operation associated with a mathematical computation operation, a scheduling operation, a task management operation, etc. In accordance with an embodiment of the present invention, the CPU 1600 manages a Packet Service Slice block (PSSB) task 1610. A hatched area shown in FIG. 16 represents a S Inter Process Communication (SIPC) task. Because the SIPC task is not directly associated with the present invention, a detailed description of the SIPC task will be omitted. Here, the PSSB task 1610 receives GTP-u packet data transferred through a GTP tunnel or receives IP packet data from the external network, e.g., the Internet, and performs various protocol processes.

The PSSB task 1610 includes a TFT packet filtering procedure 1611 and a packet processor 1613. The TFT packet filtering procedure 1611 performs packet filtering associated with TFTs. The packet processor 1613 processes a packet corresponding to a result of the TFT packet filtering by the TFT packet procedure 1611. The RAM 1650 includes a TFT table 1651 and a resource table 1653. The TFT table 1651 stores information associated with the TFTs stored in the GGSN. The TFT packet filtering procedure 1611 refers to the TFT table 1651 associated with the packet data incoming from the GGSN and performs the packet filtering. Here, TFT packet filters stored in the TFT table 1651 use an IPv4-compatible IPv6 address and an IPv4-mapped IPv6 address and hence holds a 32-bit IPv4 address in accordance with an embodiment of the present invention. Here, the IPv4-compatible IPv6 address is selectively used when an opposite network can support the IPv6 address, an opposite or destination IPv4 address can be recognized, and communication is performed through the IPv6 network. The IPv4-mapped IPv6 address is selectively used when an opposite network does not support an IPv6 address, but communication is performed using the IPv6 address.

The SAR module 1670 reassembles Asynchronous Transfer Mode (ATM) cells received from the external network, transfers the reassembled ATM cells to an IN path within the PSSB task 1610. The SAR module 1670 segments packet data to be transferred from the GGSN to the external network, i.e., packet data to be transferred through IN, P and S paths of the PSSB task 1610, in units of ATM cells, and outputs the segmented packet data to the duplexer 1690. The duplexer 1690 selectively receives packet data from the external network and transmits packet data from the GGSN to all function blocks physically coupled to the duplexer 1690.

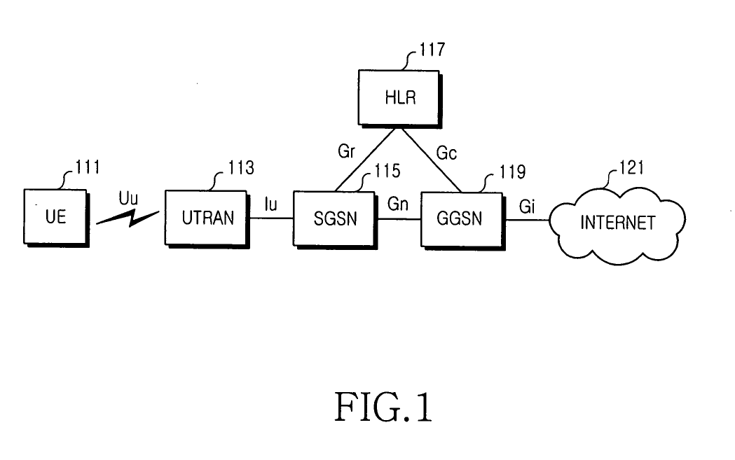

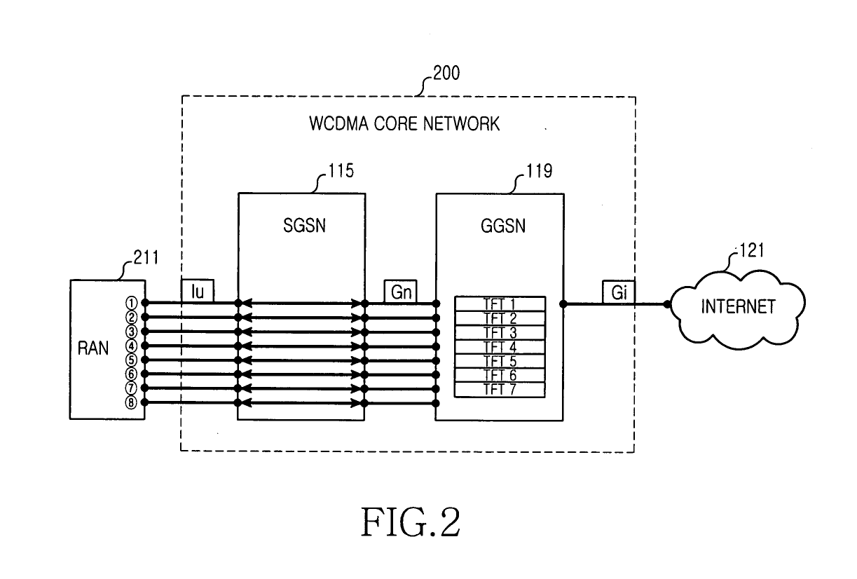

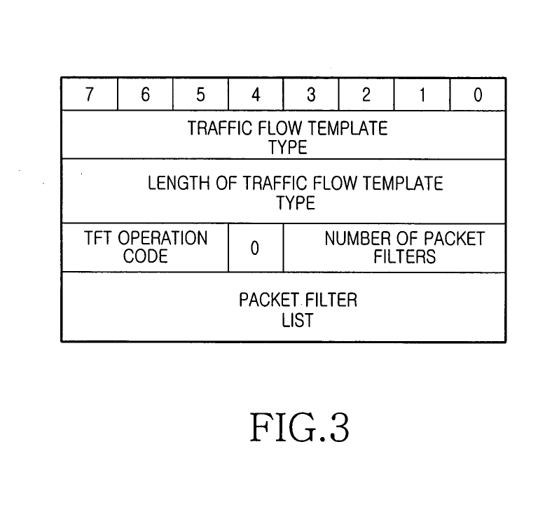

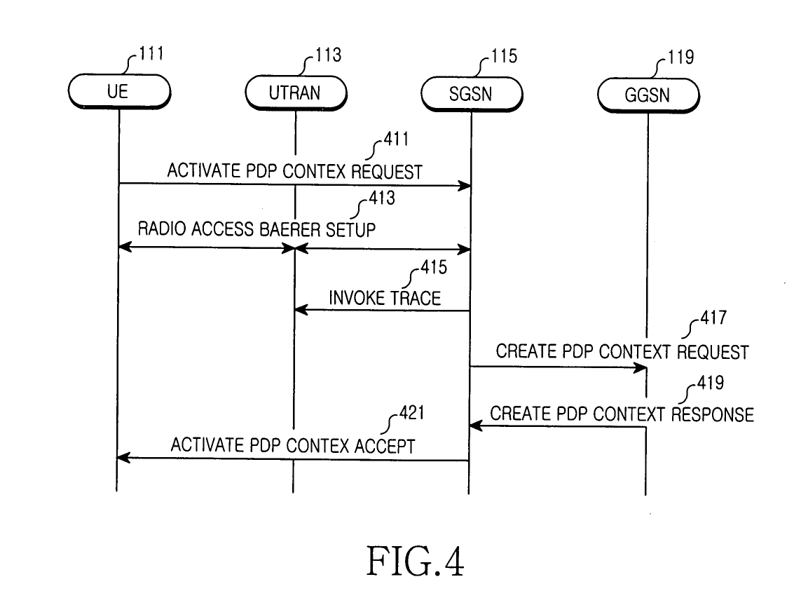

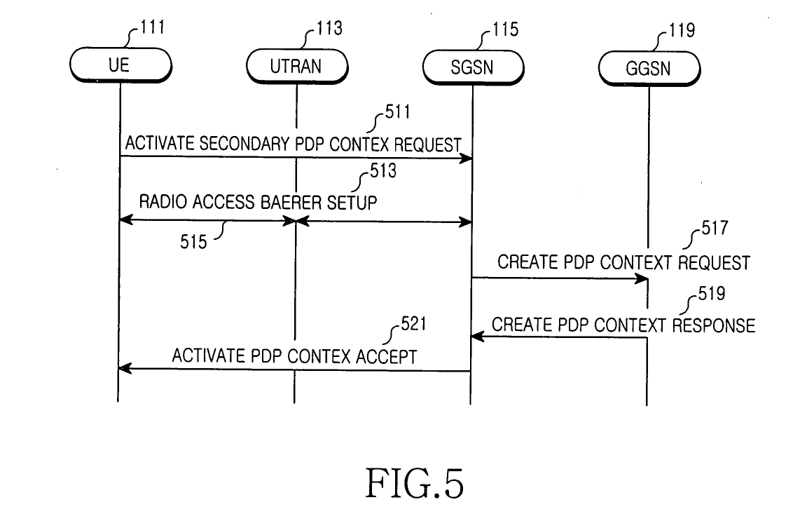

The TFT packet-filtering device shown in FIG. 16 must consider a secondary PDP context activation procedure and a TFT information storage procedure so that TFT packet filtering for the incoming packet data can be performed. The secondary PDP context activation procedure and the TFT information storage process to be considered for the TFT packet filtering will be described. The architectures of the UMTS network and the CN (Core Network) are almost identical with those in FIGS. 1 and 2 mentioned in the “Description of the Related Art” above. Only the TFT packet-filtering device in accordance with the embodiment of the present invention is based on differentiated architecture. It is assumed that the present invention uses an IPv4-compatible IPv6 address and an IPv4-mapped IPv6 address being IPv4-embedded IPv6 addresses. Thus, the TFT packet filters perform TFT packet-filtering operations using only the IPv4 address contained in the IPv4-embedded IPv6 address. It should be noted that procedures of activating Packet Data Protocol (PDP) contexts, i.e., a primary PDP context and secondary PDP contexts are the same as the procedures shown in FIGS. 4 and 5.

In order for the TFT packet filtering to be performed in accordance with the embodiment of the present invention, the secondary PDP context activation procedure must be first performed. The secondary PDP context activation procedure must be performed is because TFTs are generated in the secondary PDP context activation procedure rather than in the primary PDP context activation procedure. Referring to FIGS. 5 and 15, the UE 1511 transmits an “ACTIVATE SECONDARY PDP CONTEXT REQUEST” message to the SGSN 1515, and the SGSN 1515 transmits a “CREATE PDP CONTEXT REQUEST” message to the GGSN 1519, such that the secondary PDP context activation procedure is initiated. As described in relation to FIG. 5, TFT information is generated in the UE 1511, and the “ACTIVATE SECONDARY PDP CONTEXT REQUEST” message containing the TFT information is transferred to the GGSN 1519. Then, the GGSN 1519 activates secondary PDP contexts using the TFT information contained in the “ACTIVATE SECONDARY PDP CONTEXT REQUEST” message and generates secondary GTP tunnels, such that packet data incoming from the external network through the secondary GTP tunnels can be processed.

Next, the TFT information storage procedure must be performed in order for the TFT packet filtering to be performed in accordance with the present invention.

As described above, the TFT information transferred from the UE 1511 is stored in the GGSN 1519. At this time, necessary information items of the TFT information such as the number of packet filters, packet filter contents, etc. are stored so that TFT packet filtering for packet data incoming from the external network can be performed. In other words, the TFT information is contained in the “ACTIVATE SECONDARY PDP CONTEXT REQUEST” message, and is transferred to the SGSN 1515. Furthermore, the TFT information is contained in the “CREATE PDP CONTEXT REQUEST” message, and is transferred to the GGSN 1519. The GGSN 1519 extracts and stores only necessary TFT information.

In the embodiment of the present invention, two TFT information storage methods are proposed as in the following.

(1) IPv6 Source Address Type Method

As described above, TFT information generated by the UE 1511 is stored in the GGSN 1519. The GGSN 1519 extracts necessary TFT information from information that is transmitted from the UE 1511, and stores the extracted information as the TFT information. In other words, the GGSN 1519 stores the TFT information configuring the number of packet filters, packet filter contents, etc. so that the TFT packet filtering can be easily performed. At this time, where TFT packet filters correspond to an IPv6 source address type, and a corresponding filter coefficient corresponds to an IPv4-embedded IPv6 address, the GGSN 1519 does not store a 128-bit address value and a 128-bit mask value associated with the IPv4-embedded IPv6 address, selects low-order 32 bits indicating an IPv4 address of the IPv4-embedded IPv6 address, and stores only a 32-bit address value and a 32-bit mask value, as the TFT information. The TFT packet filters are based on an IPv6 source address type, but filter coefficients stored in the TFT packet filters are based on an IPv4 address format.

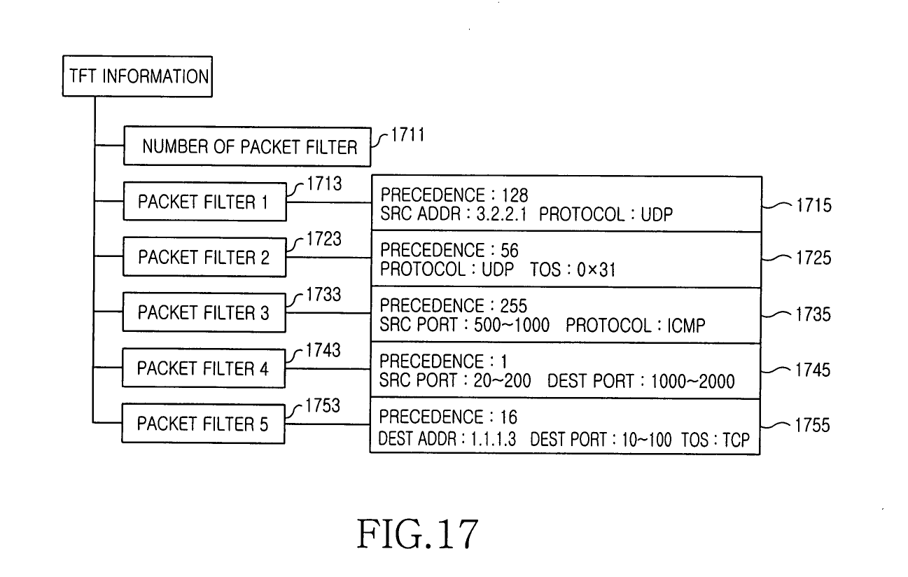

The GGSN 1519 stores the TFT information using only necessary information from the TFT information contained in the “ACTIVATE SECONDARY PDP CONTEXT REQUEST” message transmitted from the UE 1511. The TFT information stored in the GGSN 1519, i.e., the TFT information stored in the RAM 1650 of the TFT packet-filtering device, will be described with reference to FIG. 17.

FIG. 17 is a block diagram illustrating the TFT information stored in the TFT table 1651 shown in FIG. 16.

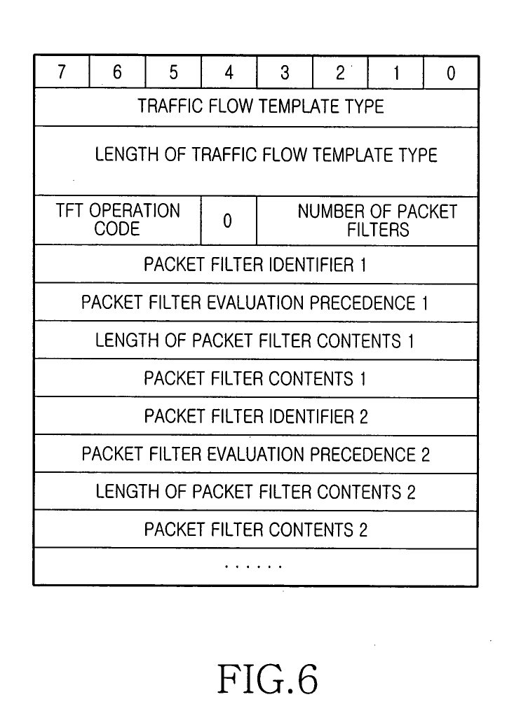

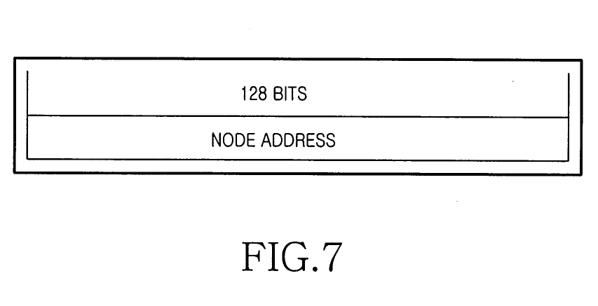

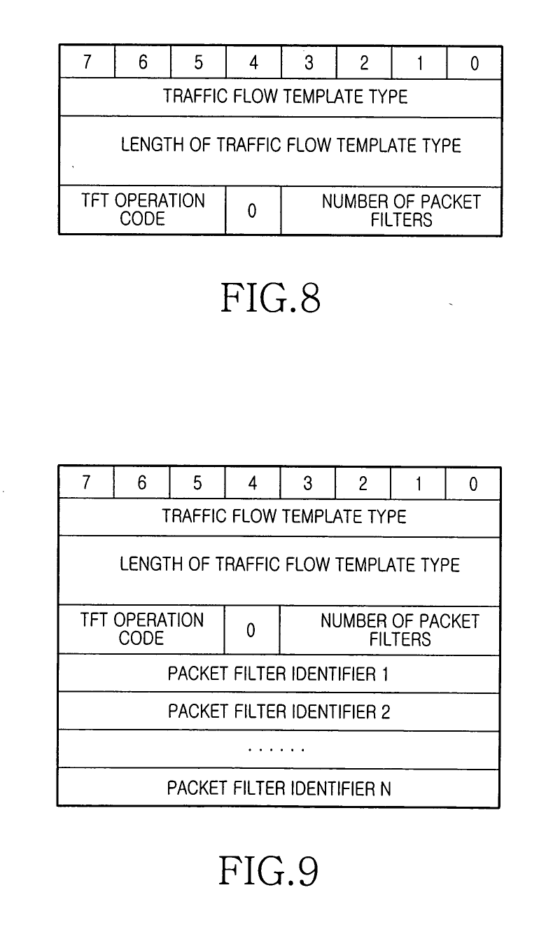

Referring to FIG. 17, the TFT information is classified into a “NUMBER OF PACKET FILTERS” field 1711, “PACKET FILTER IDENTIFIER” fields 1713, 1723, 1733, 1743 and 1753, “PACKET FILTER EVALUATION PRECEDENCE” fields (not shown), and “PACKET FILTER CONTENTS” fields 1715, 1725, 1735, 1745 and 1755. The “NUMBER OF PACKET FILTERS” field 1711 indicates the number of packet filters stored in a corresponding TFT. The “PACKET FILTER IDENTIFIER” fields 1713, 1723, 1733, 1743 and 1753 indicate packet filter IDs for indicating the packet filters stored in the TFT. The “PACKET FILTER IDENTIFIER” fields 1713, 1723, 1733, 1743 and 1753 have one to one correspondence with the “PACKET FILTER EVALUATION PRECEDENCE” fields (not shown) or the “PACKET FILTER CONTENTS” fields 1715, 1725, 1735, 1745 and 1755. The above-described fields are stored on the basis of one to one correspondence. The stored TFT information shown in FIG. 17 is general TFT information, i.e., information necessary for the TFT packet filtering separately selected from the TFT information shown in FIG. 6. Since the TFT packet filtering associated with the IPv4-embedded IPv6 address is performed in accordance with the embodiment of the present invention, source and destination address contents are considered important.

For example, where the IPv4-embedded IPv6 address is “::3.2.2.1” and the protocol type is UDP in the first “PACKET FILTER CONTENTS” field 1715 contained in the TFT information received from the UE 1511, the GGSN 1519 generates at least one packet filter having the IPv6 source address of “::3.2.2.1” and the UDP contents using an IPv6 source address type method, and stores the generated packet filter in the TFT table 1651 of the RAM 1650 contained in the TFT packet-filtering device.

If the TFT information is stored using the IPv6 source address type method previously described. Next, the case where the TFT information is stored using an IPv4-embedded IPv6 source address type method will be described.

(2) IPv4-Embedded IPv6 Source Address Type Method

When an IP address is an IPv4-embedded IPv6 source address when the UE 1511 generates TFT information, the UE 1511 sets a TFT packet filter type to an IPv4-embedded IPv6 source address type, and extracts only a low-order 32-bit IPv6 address. The UE 1511 configures at least one new TFT packet filter using the low-order 32 bits extracted from the IPv4-embedded IPv6 source address, and transmits the new TFT packet filter to the GGSN 1519. The IPv4-embedded IPv6 source address type method is a method for enabling the UE 1511 to extract the low-order 32 bits of the IPv4-embedded IPv6 source address, to configure the new TFT packet filter and to transmit the new TFT packet filter. In order for the IPv4-embedded IPv6 source address type method to be supported, an item of the IPv4-embedded IPv6 source address type must be added to items of the packet filter component types shown in the above Table 2. We assume that a packet filter component type ID associated with the IPv4-embedded IPv6 source address type is set to “00100001”. Here, “00100001” is a value that is previously reserved among the packet filter component type IDs.

Subsequently, where the IPv6 source address type method is used, the TFT packet filter corresponds to an IPv6 source address type, and the length of the stored TFT packet filter is 32 bits. However, where the IPv4-embedded IPv6 source address type method is used, the TFT packet filter corresponds to an IPv4-embedded IPv6 source address type, and the length of the stored TFT packet filter is 32 bits.

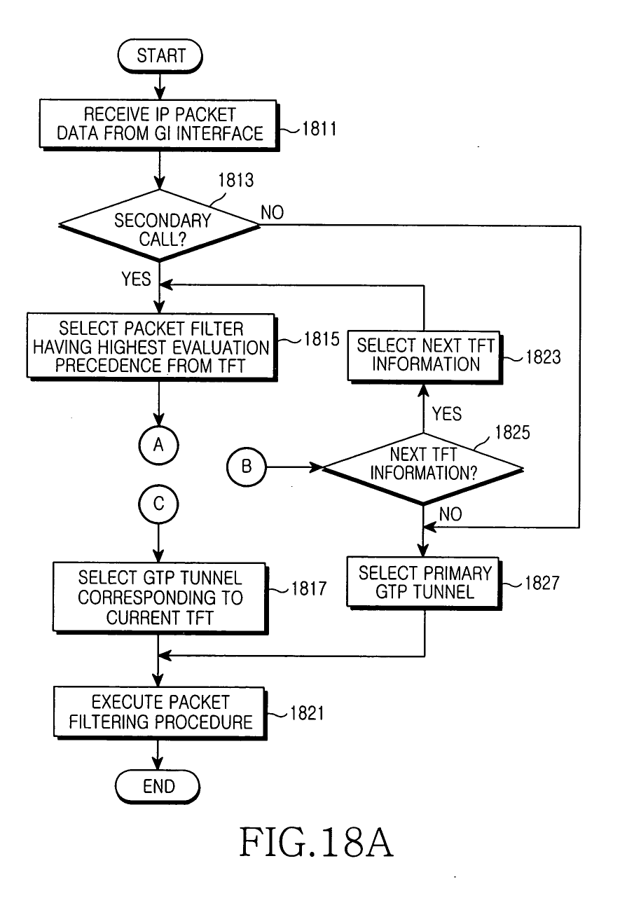

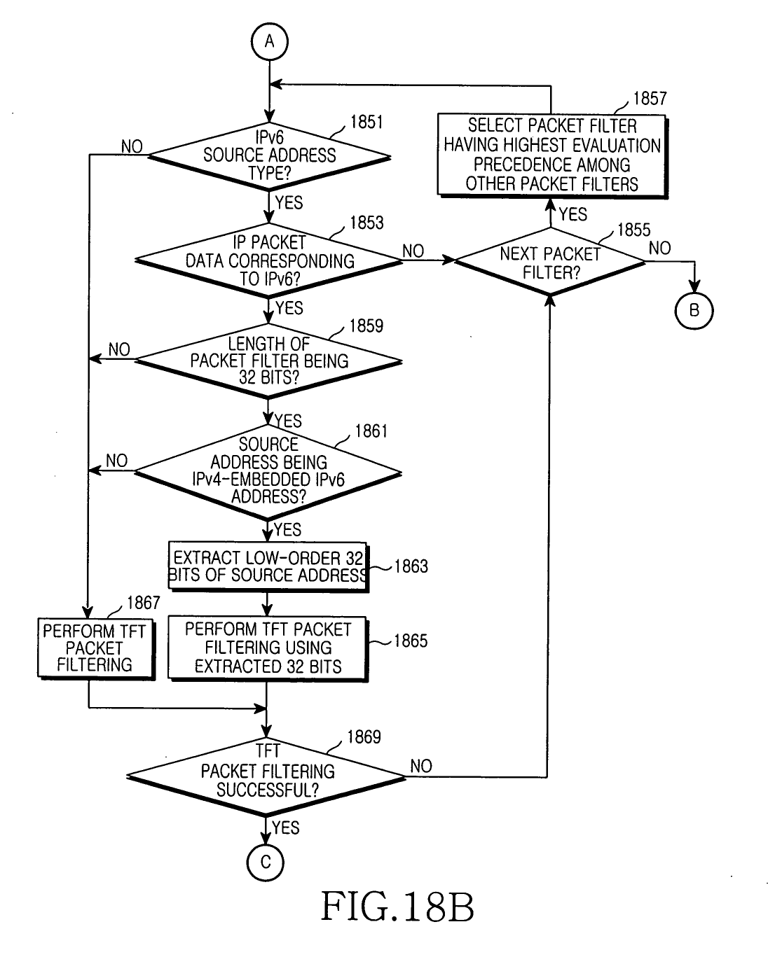

The TFT packet filtering in the case where the IPv6 source address type method is used will be described with reference to FIGS. 18A and 18B.

FIGS. 18A and 18B are flow charts illustrating the TFT packet filtering operation in the case where the IPv6 source address type method is used.

Referring to FIG. 18A, if the GGSN 1519 receives IP packet data through the Gi interface at step 1811, the GGSN 1519 proceeds to step 1813. At the above step 1813, the GGSN 1519 confirms a destination address of the received IP packet data and determines whether a secondary call is set up for information matching a PDP address. Here, the reason why the secondary call is set up is to determine whether a secondary GTP tunnel is present. In other words, since TFT packet filtering is disabled where the secondary GTP tunnel does not exist, the determination is made as to whether the secondary call is present. If the secondary call is not set up as a result of the determination, the GGSN 1519 proceeds to step 1827. The GGSN 1519 selects a primary GTP tunnel at the above step 1827, and proceeds to step 1821.

If the secondary call is set up as the result of the determination at the above step 1813, the GGSN 1519 proceeds to step 1815. The GGSN 1519 selects the secondary GTP tunnel and selects a TFT packet filter having the highest evaluation precedence from the first TFT information at the above step 1815, and the GGSN 1519 proceeds to step 1851. The GGSN 1519 determines, at step 1851, whether the TFT packet filter having the highest evaluation precedence corresponds to an IPv6 source address type. If the TFT packet filter having the highest evaluation precedence does not correspond to the IPv6 source address type, the GGSN 1519 proceeds to step 1867. The GGSN 1519 performs a general TFT packet filtering operation at step 1867 and the GGSN 1519 proceeds to step 1869. If the TFT packet filter having the highest evaluation precedence corresponds to the IPv6 source address type as the result of the determination at step 1851, the GGSN 1519 proceeds to step 1853. The GGSN 1519 determines, at step 1853, whether an IP version of the IP packet data received through the Gi interface and an IP version of a source address are an IPv6. If the IP version of the received IP packet data is not the IPv6, the GGSN 1519 proceeds to step 1855. At step 1855, the GGSN 1519 determines whether other TFT packet filters are present within the first TFT information. If other TFT packet filters are present within the first TFT information as a result of the determination, the GGSN 1519 proceeds to step 1857. The GGSN 1519 selects a TFT packet filter having the highest evaluation precedence among other packet filters at the step 1857 and returns to the above step 1851. If other TFT packet filters do not exist as a result of the determination at step 1855, the GGSN 1519 proceeds to step 1825. The GGSN 1519 determines, at step 1825, whether the next TFT information is present. If the next TFT information is present as a result of the determination, the GGSN 1519 proceeds to step 1823. The GGSN 1519 selects the next TFT information at step 1823 and then returns to step 1815. If the next TFT information does not exist as the result of the determination at the above step 1825, the GGSN 1519 proceeds to step 1827. The GGSN 1519 selects the primary GTP tunnel at the above step 1827, and proceeds to step 1821.

If the IP version of the received IP packet data is the IPv6 as the result of the determination at step 1853, the GGSN 1519 proceeds to step 1859. The GGSN 1519 determines, at 1859, whether the length of the TFT packet filter is 32 bits. If the length of the TFT packet filter is not 32 bits as a result of the determination, the GGSN 1519 proceeds to step 1867. Since the fact that the length of the TFT packet filter is not 32 bits indicates that a source address is a general 128-bit IPv6 address, the GGSN 1519 proceeds to step 1867 to perform a general TFT packet filtering operation. If the length of the TFT packet filter is 32 bits as the result of the determination at step 1859, the GGSN 1519 proceeds to step 1861. The GGSN 1519 determines, at step 1861, whether the source address of the received IP packet data is an IPv4-embedded IPv6 address. If the source address is not an IPv4-embedded IPv6 address as a result of the determination, the GGSN 1519 proceeds to step 1867. The fact that the source address is not an IPv4-embedded IPv6 address indicates that the source address is a 32-bit IPv4 address. The GGSN 1519 performs a general TFT packet filtering operation at the above step 1867.

If the source address is an IPv4-embedded IPv6 address as the result of the determination at the above step 1861, the GGSN 1519 proceeds to step 1863. The GGSN 1519 extracts a low-order 32-bit source address, and proceeds to step 1865. The GGSN 1519 performs TFT packet filtering using the extracted 32 bits at the above step 1865 and then proceeds to step 1869. The TFT packet filtering performed at step 1865 uses the proposed IPv6 source address type method. The GGSN 1519 determines, at step 1869, whether the TFT packet filtering is successful. If the TFT packet filtering is unsuccessful as a result of the determination, the GGSN 1519 proceeds to step 1855. If the TFT packet filtering is successful as the result of the determination at step 1869, the GGSN 1519 proceeds to the above step 1817.

The GGSN 1519 selects a GTP tunnel corresponding to current TFT information at step 1817, and then proceeds to step 1821. At step 1821, the GGSN 1519 executes a packet filtering procedure for processing the received IP packet data and terminates the TFT packet filtering operation.

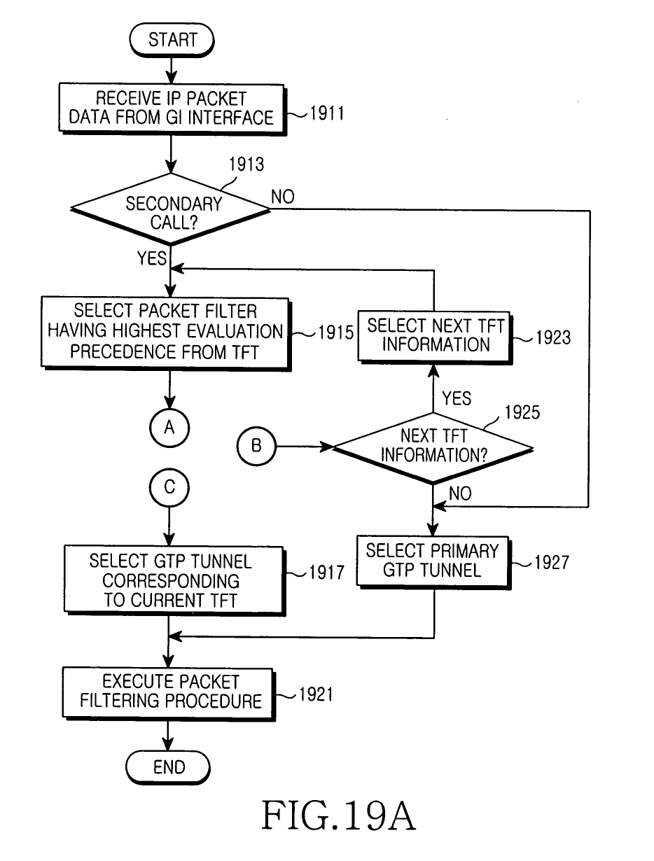

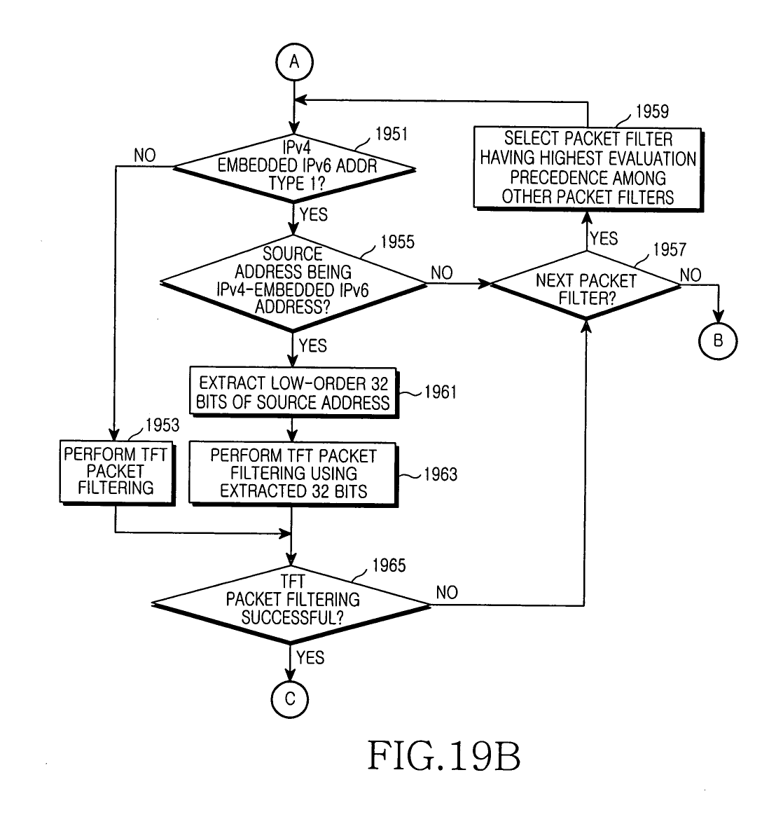

The TFT packet filtering using the IPv6 source address type method has been described with reference to FIGS. 18A and 18B. Next, TFT packet filtering using the IPv4-embedded IPv6 source address type method will be described with reference to FIGS. 19A and 19B.

FIGS. 19A and 19B are flow charts illustrating a TFT packet filtering operation when the IPv4-embedded IPv6 source address type method is used.

Referring to FIG. 19A, if the GGSN 1519 receives IP packet data through the Gi interface at step 1911, the GGSN 1519 proceeds to step 1913. At step 1913, the GGSN 1519 confirms a destination address of the received IP packet data and determines whether a secondary call is set up for information matching a PDP address. Here, the secondary call is set up to determine whether a secondary GTP tunnel is present. In other words, since TFT packet filtering is disabled where the secondary GTP tunnel does not exist, the determination is made as to whether the secondary call is present. If the secondary call is not set up as a result of the determination, the GGSN 1519 proceeds to step 1927. The GGSN 1519 selects a primary GTP tunnel at step 1927, and proceeds to step 1921.

If the secondary call is set up as the result of the determination at step 1913, the GGSN 1519 proceeds to step 1915. The GGSN 1519 selects the secondary GTP tunnel and selects a TFT packet filter having the highest evaluation precedence from the first TFT information at step 1915, and the GGSN 1519 proceeds to step 1951. The GGSN 1519 determines, at step 1951, whether the TFT packet filter having the highest evaluation precedence corresponds to an IPv4-embedded IPv6 address type. If the TFT packet filter having the highest evaluation precedence does not correspond to an IPv4-embedded IPv6 address type, the GGSN 1519 proceeds to step 1953. The GGSN 1519 performs a general TFT packet filtering operation at step 1953 and the GGSN 1519 proceeds to step 1965. If the TFT packet filter having the highest evaluation precedence corresponds to the IPv4-embedded IPv6 address type as the result of the determination at step 1951, the GGSN 1519 proceeds to step 1955. The GGSN 1519 determines, at step 1955, whether the source address of the received IP packet data is an IPv4-embedded IPv6 address. If the source address of the received IP packet data is not an IPv4-embedded IPv6 address as a result of the determination, the GGSN 1519 proceeds to step 1957. The GGSN 1519 determines, at step 1957, whether other TFT packet filters are present within the first TFT information. If other TFT packet filters are present within the first TFT information as a result of the determination, the GGSN 1519 proceeds to step 1959. The GGSN 1519 selects a TFT packet filter having the highest evaluation precedence among other packet filters at step 1959 and returns to step 1951. If other TFT packet filters do not exist as a result of the determination at step 1957, the GGSN 1519 proceeds to step 1925. The GGSN 1519 determines, at step 1925, whether the next TFT information is present. If the next TFT information is present as a result of the determination, the GGSN 1519 proceeds to step 1923. The GGSN 1519 selects the next TFT information at 1923 and then returns to step 1915. If the next TFT information does not exist as a result of the determination at step 1925, the GGSN 1519 proceeds to step 1927. The GGSN 1519 selects the primary GTP tunnel at step 1927, and proceeds to step 1921.

If the source address of the received IP packet data is an IPv4-embedded IPv6 address as the result of the determination at step 1955, the GGSN 1519 proceeds to step 1961. The GGSN 1519 extracts low-order 32 bits from the IPv4-embedded IPv6 address and then proceeds to step 1963. The GGSN 1519 performs TFT packet filtering using the extracted 32 bits at step 1963 and then proceeds to step 1965. The GGSN 1519 determines, at step 1965, whether the TFT packet filtering is successful. If the TFT packet filtering is unsuccessful as a result of the determination, the GGSN 1519 proceeds to step 1957. If the TFT packet filtering is successful as the result of the determination at step 1965, the GGSN 1519 proceeds to step 1917. The GGSN 1519 selects a GTP tunnel corresponding to current TFT information at step 1917, and then proceeds to step 1921. The GGSN 1519 executes a packet filtering procedure for processing the received IP packet data at step 1921, and terminates the TFT packet filtering operation.

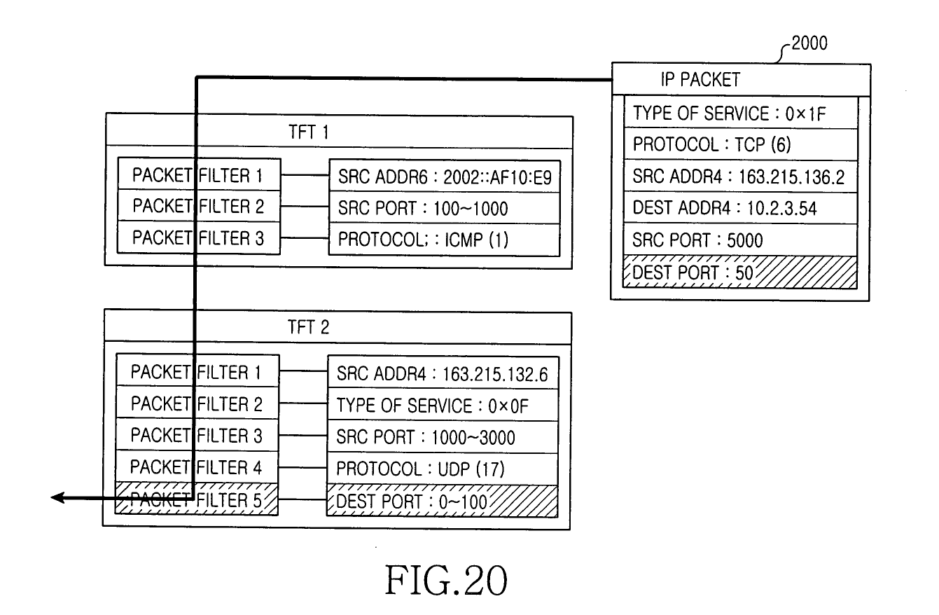

The general TFT packet filtering operation will be described with reference to FIG. 20.

FIG. 20 is a block diagram illustrating the general TFT packet filtering operation performed by the TFT packet filtering procedure 1611 shown in FIG. 16.

Referring to FIG. 20, if IP packet data 2000 is received from the external network through the Gi interface of the GGSN 1519, i.e., if the IP packet data 2000 is input through the duplexer 1690, the input IP packet data 2000 is transferred to the TFT packet filtering procedure 1611 through the SAR module 1670. The TFT packet filtering procedure 1611 performs the TFT packet filtering using TFT information stored in the TFT table 1651 of the RAM 1650. If the TFT table 1651 stores two TFT information items of TFT 1 and TFT 2 as shown in FIG. 20, the TFT packet filtering procedure 1611 first tries to perform TFT packet filtering for the IP packet data 2000 in relation to a packet filter 1 of the TFT 1. In the IP packet data 2000, a Type Of Service (TOS) is “0x1F”, a protocol is TCP (6), a source address is “2.2.2.2”, a destination address is “3.3.3.3”, a source port number is 5000 and a destination port number is 50.

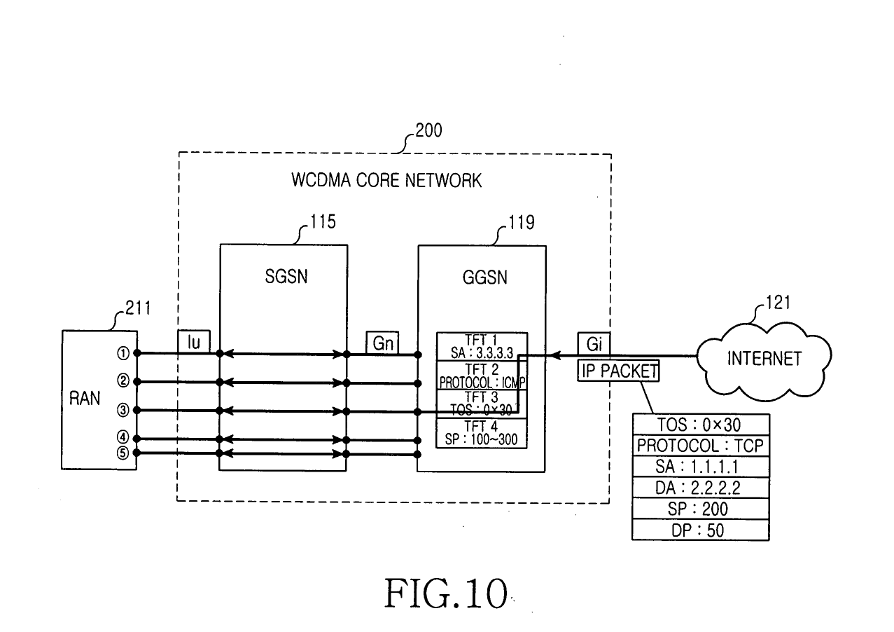

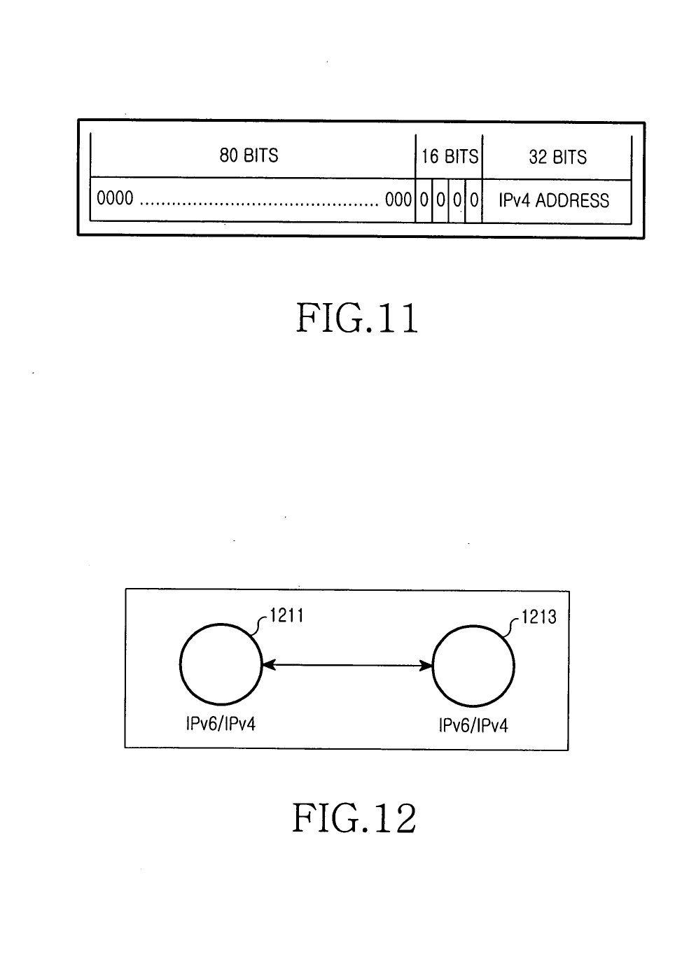

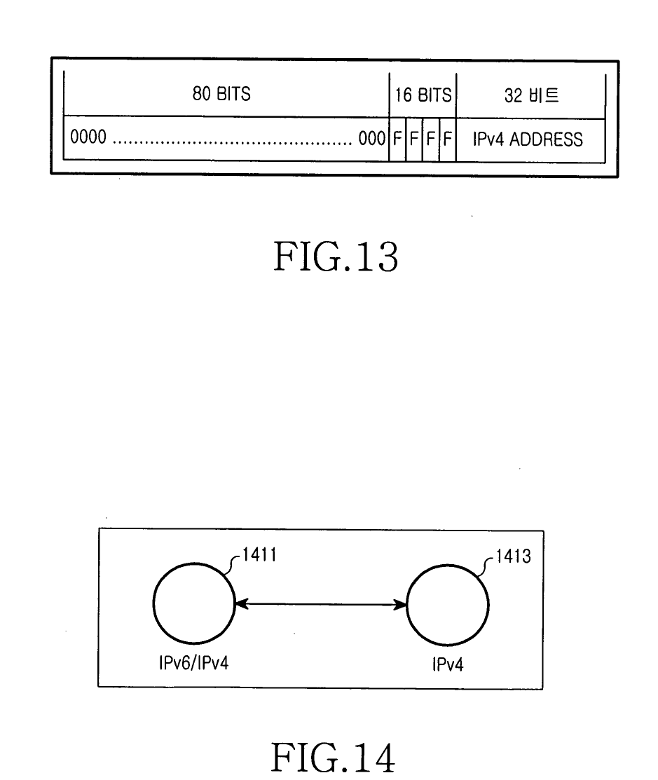

When TFT packet filtering associated with the packet filter 1 of the TFT 1 for the IP packet data 2000 is performed, the TFT packet filtering will be unsuccessful since the source address of the packet filter 1 of the TFT 1 is “1.1.1.1”. Then, the TFT packet filtering procedure 1611 performs the packet filtering associated with a packet filter 2 of the TFT 1. However, since a source port range associated with the packet filter 2 of the TFT 1 is between 100 and 1000, the source port number 5000 of the IP packet data 2000 is not contained in the source port range, such that the TFT packet filtering is unsuccessful. Thus, a TFT packet filter capable of being mapped to the input IP packet data 2000 is searched for. The packet filtering is performed by the TFT packet filter mapped to the IP packet data 2000, and the IP packet data 2000 is transferred to the SGSN 1515 through a corresponding tunnel. In FIG. 20, since the destination port of the IP packet data is contained in a destination port range for a packet filter 5 of the TFT 2, the IP packet data 2000 uses a GTP tunnel corresponding to the TFT 2. The TFT packet filtering operation for the packet data incoming from the external network is the same as in FIG. 10 as mentioned in the “Description of the Related Art” above.

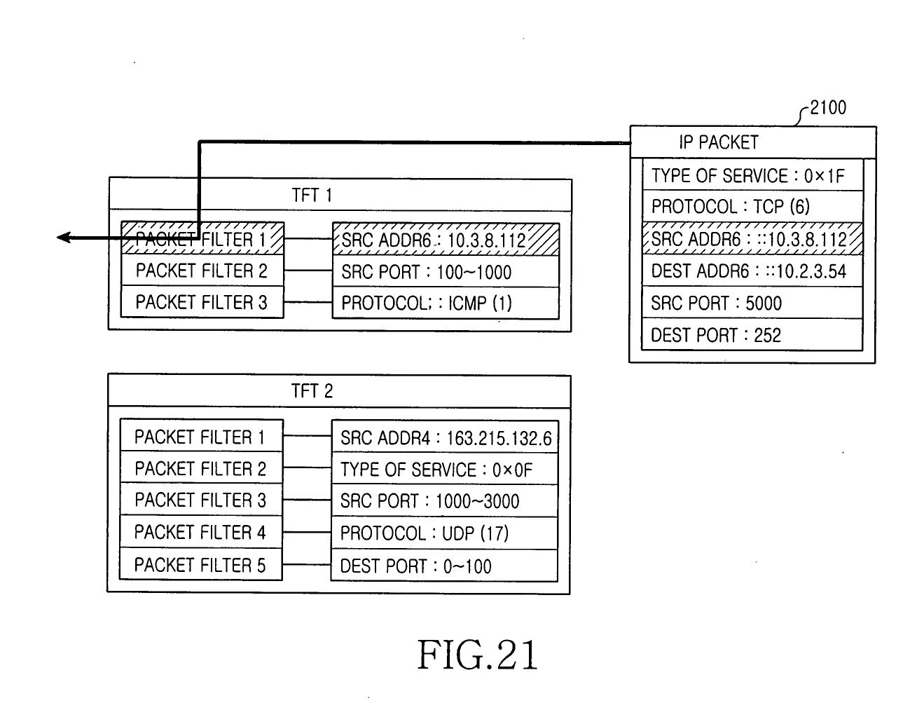

The TFT packet filtering using the IPv6 source address type method will be described with reference to FIG. 21.

FIG. 21 is a block diagram illustrating a TFT packet filtering operation using the IPv6 source address type method performed by the TFT packet filtering procedure 1611 shown in FIG. 16.

Referring to FIG. 21, if IP packet data 2100 is received from the external network through the Gi interface of the GGSN 1519, i.e., if the IP packet data 2100 is input through the duplexer 1690, the input IP packet data 2100 is transferred to the TFT packet filtering procedure 1611 through the SAR module 1670. The TFT packet filtering procedure 1611 executes the TFT packet filtering using TFT information stored in the TFT table 1651 of the RAM 1650. If the TFT table 1651 stores two TFT information items of TFT 1 and TFT 2 as shown in FIG. 21, the TFT packet filtering procedure 1611 first tries to perform TFT packet filtering for the IP packet data 2100 in relation to a packet filter 1 of the TFT 1. In the IP packet data 2100, a TOS is “0x1F”, a protocol is TCP (6), a source address is “::10.3.8.112”, a destination address is “::10.2.3.54”, a source port number is 5000 and a destination port number is 50. Here, the source address and the destination address are IPv4-compatible IPv6 addresses and are expressed as low-order 32 bits, respectively.

When TFT packet filtering associated with the packet filter 1 of the TFT 1 for the IP packet data 2100 is performed, the TFT packet filtering will be successful since the source address of the packet filter 1 of the TFT 1 is “10.3.8.112”. Then, the TFT packet filtering procedure 1611 executes the packet filtering using the packet filter matched to the IP packet data 2100 and then transfers the packet data 2100 to the SGSN 1515 through a corresponding GTP tunnel. Since the source address of the packet data 2100 is matched to the source address associated with the packet filter 1 of the TFT 1, the IP packet data 2100 uses the GTP tunnel corresponding to the TFT 1.

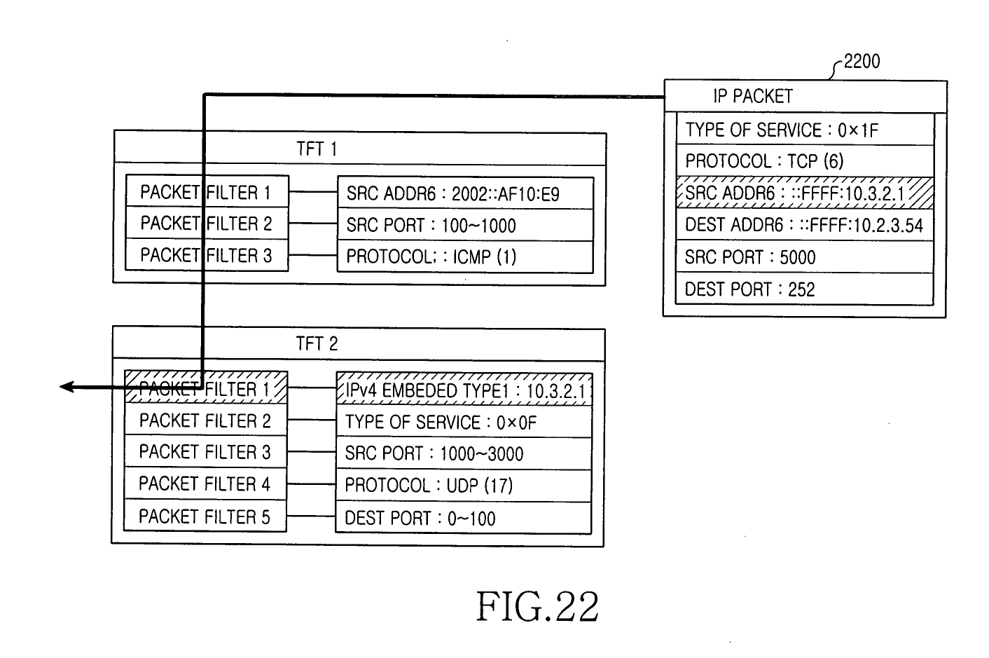

The TFT packet filtering using the IPv4-embedded IPv6 source address type method will be described with reference to FIG. 22.

FIG. 22 is a block diagram illustrating a TFT packet filtering operation using the IPv4-embedded IPv6 source address type method performed by the TFT packet filtering procedure 1611 shown in FIG. 16.

Referring to FIG. 22, if IP packet data 2200 is received from the external network through the Gi interface of the GGSN 1519, i.e., if the IP packet data 2200 is input through the duplexer 1690, the input IP packet data 2200 is transferred to the TFT packet filtering procedure 1611 through the SAR module 1670. The TFT packet filtering procedure 1611 executes the TFT packet filtering using TFT information stored in the TFT table 1651 of the RAM 1650. If the TFT table 1651 stores two TFT information items of TFT 1 and TFT 2 as shown in FIG. 22, the TFT packet filtering procedure 1611 first tries to perform TFT packet filtering for the IP packet data 2200 in relation to a packet filter 1 of the TFT 1. In the IP packet data 2200, a TOS is “0x1F”, a protocol is TCP (6), a source address is “::FFFF:10.3.2.1”, a destination address is “::FFFF:10.2.3.54”, a source port number is 5000 and a destination port number is 50. Here, the source address and the destination address are IPv4-mapped IPv6 addresses, and are expressed as low-order 32 bits, respectively.

When the TFT packet filtering procedure 1611 executes TFT packet filtering associated with a packet filter 1 of the TFT 1 for the IP packet data 2000, the TFT packet filtering will be unsuccessful since the source address of the packet filter 1 of the TFT 1 is “2002::AF10:E9”. Further, since a source port range associated with the packet filter 2 of the TFT 1 is between 100 and 1000, the TFT packet filtering is unsuccessful. Furthermore, since the protocol associated with the packet filter 3 of the TFT 1 is ICMP (1), the TFT packet filtering will be unsuccessful. When the TFT packet filtering procedure 1611 executes the TFT packet filtering associated with the packet filter 1 of the TFT 2, the TFT packet filtering will be successful since an IPv4 embedded type 1 corresponds to “10.3.2.1”. Then, the TFT packet filtering procedure 1611 executes the packet filtering using the TFT packet filter matched to the IP packet data 2200, and transfers the IP packet data 2200 to the SGSN 1515 through a corresponding GTP tunnel. In FIG. 22, since the source address of the IP packet data 2200 matches an IPv4 embedded type 1 associated with the packet filter 1 of the TFT 2, the IP packet data 2200 uses a GTP tunnel corresponding to the TFT 2.

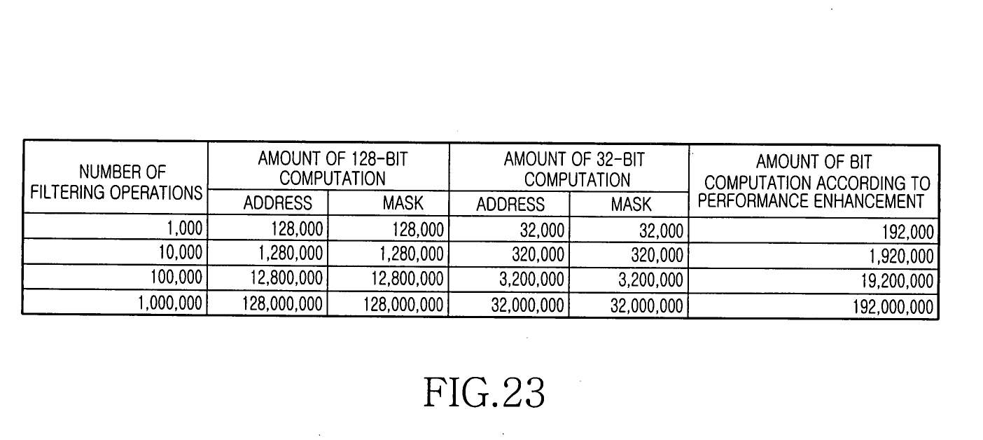

A comparison between an amount of bit computation according to a TFT packet filtering operation where the IPv6 source address type method and IPv4-embedded IPv6 source address type method in accordance with the present invention are used and an amount of bit computation according to the general TFT packet filtering operation will be described with reference to FIG. 23.

FIG. 23 is a table illustrating an amount of bit computation according to a TFT packet filtering operation when the IPv6 source address type method and IPv4-embedded IPv6 source address type method are used as compared with an amount of bit computation according to the general TFT packet filtering operation in accordance with the present invention.

Referring to FIG. 23, there are shown an amount of bit computation according to where a 128-bit IPv6 address is used and an amount of bit computation according to where 32 bits are extracted from the 128-bit IPv6 address according to the number of TFT packet filtering operations. There are shown an amount of 128-bit computation and an amount of 32-bit computation where the number of TFT packet filtering operations is 1,000, 100,000 and 1,000,000. As shown in FIG. 23, a difference between an amount of bit computation where 128 bits are used and an amount of bit computation where 32 bits are used is remarkably large.

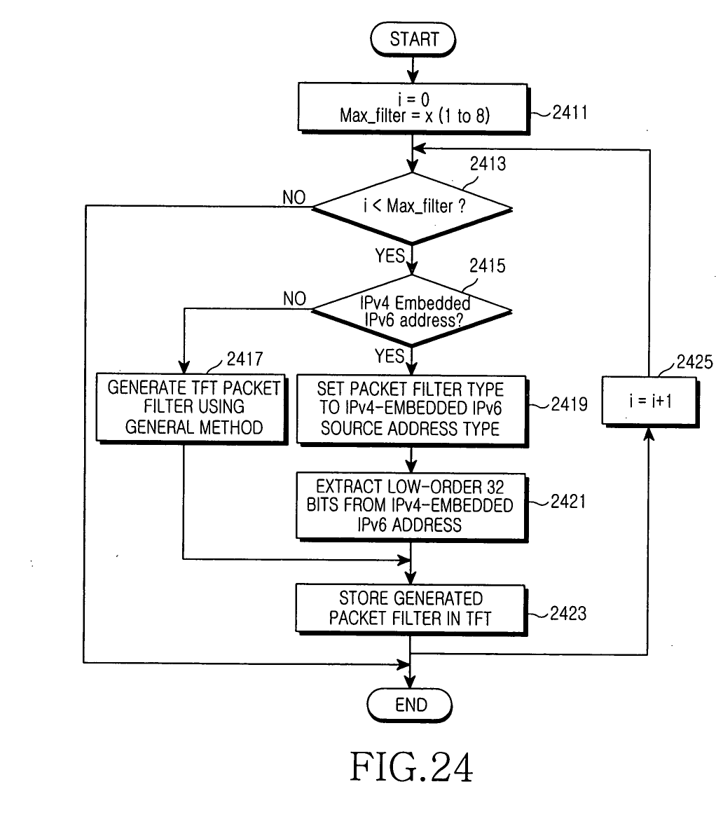

In the IPv4-embedded IPv6 source address type method, the UE 1511 sets the TFT packet filter type to the IPv4-embedded IPv6 source address type, extracts a low-order 32-bit IPv6 address from an IPv4-embedded IPv6 source address, and configures at least one new TFT packet filter using the extracted low-order 32-bit IPv6 address. In other words, the TFT configuration by the UE 1511 in the IPv4-embedded IPv6 source address type method is different from that in the IPv6 source address type method. The above-described difference will be described with reference to FIG. 24.

FIG. 24 is a flow chart illustrating a TFT packet filter generation process where the IPv4-embedded IPv6 source address type method is performed.

Referring to FIG. 24, the UE 1511 sets an arbitrary parameter i to “0” (i=0) and sets an arbitrary parameter Max_filter to “x” at step 2411, and proceeds to step 2413. Here, “x” indicates the number of packet filters capable of being configured within one TFT. For example, since the maximum number of packet filters capable of being configured is 8 as described above, “x” has an integer between 1 and 8. The number of packet filters “x” capable of being configured within one TFT is determined by a predetermined application of the UE 1511. The UE 1511 determines, at the above step 2413, whether i<Max_filter. If i≧Max_filter as a result of the determination, the UE 1511 terminates the process. If i<Max _filter as the result of the determination, the UE 1511 proceeds to step 2415. The UE 1511 determines, at step 2415, whether an IP address associated with a TFT packet filter corresponds to an IPv4-embedded IPv6 source address type. If the IP address associated with a TFT packet filter does not correspond to an IPv4-embedded IPv6 source address type, the UE 1511 proceeds to step 2417. The UE 1511 configures TFT packet filters using the general TFT packet filter generation method at the above step 2417, and proceeds to step 2423. If the IP address associated with a TFT packet filter corresponds to an IPv4-embedded IPv6 source address type, the UE 1511 proceeds to step 2419.

The UE 1511 sets a type of the packet filter to be generated to an IPv4-embedded IPv6 source address type at step 2419, and then proceeds to step 2421. The UE 1511 extracts low-order 32 bits from the IPv4-embedded IPv6 address at step 2421, and then proceeds to step 2423. The UE 1511 generates the packet filter using the extracted 32 bits and stores the generated packet filter in a corresponding TFT at step 2423, and proceeds to step 2425. The UE 1511 increments a value of the parameter i by “1” (i.e., i=i +1) at step 2425 and then proceeds to step 2413.

As apparent from the above description, the present invention provides an apparatus and method for performing TFT packet filtering, which can minimize an amount of computation associated with the packet filtering by using only low order 32 bits selected from among an IPv4 embedded IPv6 address consisting of 128 bits where a type of an IP address for packet data incoming from an external network corresponds to the IPv4-embedded IPv6 address in a mobile communication system. In other words, since a computation operation for the remaining 96 bits other than the selected low-order 32 bits is not performed, an amount of bit computation can be reduced every time TFT packet filtering is performed.

Furthermore, the apparatus and method can minimize the size of an element for storing TFT packet filters since only 32 bits rather than 128 bits are used when at least one packet filter is configured in relation to an IPv4-embedded IPv6 address, such that overall resource efficiency in the mobile communication system can be enhanced.

Although the embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

What is claimed is:

1. A method for performing Traffic Flow Template (TFT) filtering according to Internet Protocol (IP) versions in a mobile communication system capable of supporting an address of a first IP version including first bits and an address of a second IP version including second bits containing the first bits, the method comprising the steps of:
extracting IP version-based information from a source IP address; and
generating TFT information containing the extracted information and transmitting the generated TFT information to a Gateway GPRS (General Packet Radio Service) Support Node (GGSN).

2. The method as set forth in claim 1, wherein the step of extracting the IP version-based information from the source IP address is performed by extracting the first bits of the first IP version address being the IP version-based information from the second IP version address when the source IP address is the second IP version address into which the first IP version address is inserted.

3. The method as set forth in claim 1, wherein the second IP version address into which the first IP version address is inserted is a first IP version-compatible second IP version address or a first IP version-mapped second IP version address.

4. The method as set forth in claim 3, wherein the first IP version-compatible second IP version address is an address used between networks capable of supporting both a first IP of the first IP version and a second IP of the second IP version.

5. The method as set forth in claim 3, wherein the first IP version-mapped second IP version address is an address used between a network capable of supporting only a first IP of the first IP version and a network capable of supporting both the first IP of the first IP version and a second IP of the second IP version.

6. The method as set forth in claim 1, wherein the first IP version is an IPv4 (IP version 4) and the second IP version is an IP version 6 (IPv6).

7. A method for performing Traffic Flow Template (TFT) filtering according to Internet Protocol (IP) versions in a mobile communication system capable of supporting an address of a first IP version including first bits and an address of a second IP version including second bits containing the first bits, the method comprising the steps of:
when TFT information is received and the received TFT information corresponds to the second IP version address into which the first IP version address is inserted, extracting the first bits of the first IP version address from the second IP version address;
generating new TFT information from the extracted first bits of the first IP version address;
when an IP address of received packet data corresponds to the second IP version and the IP address is the second IP version address into which the first IP version address is inserted, extracting the first bits representing the first IP version address from the second IP version address; and
performing the TFT packet filtering using the first bits extracted from the received packet data.

8. The method as set forth in claim 7, wherein the second IP version address into which the first IP version address is inserted is a first IP version-compatible second IP version address or a first IP version-mapped second IP version address.

9. The method as set forth in claim 8, wherein the first IP version-compatible second IP version address is an address used between networks capable of supporting both a first IP of the first IP version and a second IP of the second IP version.

10. The method as set forth in claim 8, wherein the first IP version-mapped second IP version address is an address used between a network capable of supporting only a first IP of the first IP version and a network capable of supporting both the first IP of the first IP version and a second IP of the second IP version.

11. The method as set forth in claim 7, wherein the first IP version is an IPv4 (IP version 4) and the second IP version is an IP version 6 (IPv6).

12. A method for performing Traffic Flow Template (TFT) filtering according to Internet Protocol versions in a mobile communication system capable of supporting an address of a first IP version including first bits and an address of a second IP version including second bits containing the first bits, the method comprising the steps of:
when a source IP address is the second IP address into which the first IP version address is inserted, allowing User Equipment (UE) to extract the first bits of the first IP version address from the second IP version address;
allowing the UE to generate packet filter contents from the extracted first bits of the first IP version address, to generate TFT information containing the packet filter contents, and to transmit the generated TFT information to a Gateway GPRS (General Packet Radio Service) Support Node (GGSN);
allowing the GGSN to store the TFT information received from the UE and to extract the first bits representing the first IP version address from the second IP version address when an IP address of received packet data corresponds to the second IP version and the IP address is the second IP version address into which the first IP version address is inserted; and
allowing the GGSN to perform the TFT packet filtering using the first bits extracted from the received packet data.

13. The method as set forth in claim 12, wherein the second IP version address into which the first IP version address is inserted is a first IP version-compatible second IP version address or a first IP version-mapped second IP version address.

14. The method as set forth in claim 13, wherein the first IP version-compatible second IP version address is an address used between networks capable of supporting both a first IP of the first IP version and a second IP of the second IP version.

15. The method as set forth in claim 13, wherein the first IP version-mapped second IP version address is an address used between a network capable of supporting only a first IP of the first IP version and a network capable of supporting both the first IP of the first IP version and a second IP of the second IP version.

16. The method as set forth in claim 12, wherein the first IP version is an IPv4 (IP version 4) and the second IP version is an IP version 6 (IPv6).

17. An apparatus for performing Traffic Flow Template (TFT) filtering according to Internet Protocol (IP) versions in a mobile communication system capable of supporting an address of a first IP version including first bits and an address of a second IP version including second bits containing the first bits, the apparatus comprising:
a controller for extracting the first bits of the first IP version address from the second IP version address when TFT information is received and the received TFT information corresponds to the second IP version address into which the first IP version address is inserted, and for generating new TFT information from the extracted first bits of the first IP version address; and
a memory for storing the received TFT information as the new TFT information.

18. The apparatus as set forth in claim 17, wherein the controller comprises:
a TFT packet filtering procedure for extracting the first bits representing the first IP version address from the second IP version address when an IP address of received packet data corresponds to the second IP version and the IP address is the second IP version address into which the first IP version address is inserted, and for performing the TFT packet filtering using the first bits extracted from the received packet data.

19. The apparatus as set forth in claim 17, wherein the second IP version address into which the first IP version address is inserted is a first IP version-compatible second IP version address or a first IP version-mapped second IP version address.

20. The apparatus as set forth in claim 19, wherein the first IP version-compatible second IP version address is an address used between networks capable of supporting both a first IP of the first IP version and a second IP of the second IP version.

21. The apparatus as set forth in claim 19, wherein the first IP version-mapped second IP version address is an address used between a network capable of supporting only a first IP of the first IP version and a network capable of supporting both the first IP of the first IP version and a second IP of the second IP version.

22. The apparatus as set forth in claim 18, wherein the first IP version is an IP version 4) (IPv4) and the second IP version is an IP version 6 (IPv6).

23. An apparatus for performing Traffic Flow Template (TFT) filtering according to Internet Protocol (IP) versions in a mobile communication system capable of supporting an address of a first IP version including first bits and an address of a second IP version including second bits containing the first bits, the apparatus comprising:
User Equipment (UE) for extracting the first bits of the first IP version address from the second IP version address when a source IP address is the second IP version address into which the first IP address is inserted, for generating TFT information from the extracted first bits of the first IP version address, and for transmitting the generated TFT information to a Gateway GPRS (General Packet Radio Service) Support Node (GGSN); and
the GGSN for storing the TFT information received from the UE, for extracting the first bits representing the first IP version address from the second IP version address when an IP address of received packet data corresponds to the second IP version and the IP address is the second IP version address into which the first IP version address is inserted, and for performing the TFT packet filtering using the first bits extracted from the received packet data.

24. The apparatus as set forth in claim 23, wherein the GGSN comprises:
a TFT packet filtering procedure for extracting the first bits representing the first IP version address from the second IP version address when the IP address of the received packet data corresponds to the second IP version and the IP address is the second IP version address into which the first IP version address is inserted, and for performing the TFT packet filtering using the first bits extracted from the received packet data; and
a memory for storing the TFT information received from the UE.

25. The apparatus as set forth in claim 23, wherein the second IP version address into which the first IP version address is inserted is a first IP version-compatible second IP version address or a first IP version-mapped second IP version address.

26. The apparatus as set forth in claim 25, wherein the first IP version-compatible second IP version address is an address used between networks capable of supporting both a first IP of the first IP version and a second IP of the second IP version.

27. The apparatus as set forth in claim 25, wherein the first IP version-mapped second IP version address is an address used between a network capable of supporting only a first IP of the first IP version and a network capable of supporting both the first IP of the first IP version and a second IP of the second IP version.

28. The apparatus as set forth in claim 23, wherein the first IP version is an IP version 4 (IPv4) and the second IP version is an IP version 6 (IPv6).
